(19) United States
(12) Patent Application Publication
(10) Pub. No.: US 2026/0319485 A1
(43) Pub. Date: Oct. 15, 2026

(54) Biosecure Digital Twin for Cyber-Physical Anomaly Detection and Biological Process Modeling

(71) Applicant: Notional Resilience, Inc, San Diego, CA (US)

(72) Inventors: Ethan Samuel Bossange, San Diego, CA (US); Andrew Frank Grube, San Diego, CA (US); Michael Mylrea, San Diego, CA (US); Sri Nikhil Gupta Gaurisetti, San Diego, CA (US); Ahsan Munir, San Diego, CA (US); Rui Wheaton, San Diego, CA (US); William J. Reid, San Diego, CA (US)

(21) Appl. No.: 19/119,041

(22) PCT Filed: Oct. 6, 2023
(86) PCT No.: PCT/US2023/076288

§ 371 Date: Apr. 7, 2025

Related U.S. Application Data
(60) Provisional application No. 63/378,848, filed on Oct. 7, 2022.
(60) Provisional application No. 63/486,925, filed on Feb. 24, 2023.
(60) Provisional application No. 63/580,320, filed on Sep. 1, 2023.

(51) Int. Cl. G05B 23/02

(52) U.S. Cl. CPC G05B 23/0275; G05B 23/024; G05B 23/0283

(57) ABSTRACT

Provided herein are systems and methods that employ a biosecure digital twin which provides a high-fidelity virtual copy of a changing biopharma research, development and manufacturing environment. The biosecure digital twin can enable cyber and/or physical anomaly detection and biological process modeling.

### CROSS-REFERENCE

This application claims the benefit of U.S. Provisional Patent Application No. 63/378,848, filed Oct. 7, 2022, U.S. Provisional Patent Application No. 63/486,925 filed Feb. 24, 2023, and U.S. Provisional Patent Application No. 63/580,320 filed Sep. 1, 2023, each of which are incorporated herein by reference in their entirety.

### BACKGROUND

While improvements in sensor technology and cybersecurity network monitoring has helped improve awareness of machine state integrity, data garnered from current systems is often insufficient to form high-fidelity system models and simulations.

### SUMMARY

One aspect provided herein is a method for cyber and/or physical anomaly detection in a biopharmaceutical research and/or manufacturing (biopharma) environment, the method comprising: obtaining and aggregating data from a plurality of sources within the biopharma environment, wherein the plurality of sources comprise a plurality of biopharma production systems and machine networks, and wherein the data comprises telemetric data and metadata associated with the plurality of biopharma production systems and machine networks; providing the aggregated data to one or more machine learning algorithms for training and analysis; and using the one or more trained machine learning algorithms to detect, identify or predict one or more cyber and/or physical and/or biological and/or chemical anomalies that have occurred, are occurring, or are likely to occur within the biopharma environment.

In some embodiments, the data is aggregated using a module that is configured to (1) automatically synchronize the telemetric data across the plurality of biopharma production systems and machine networks, and (2) extract the metadata from the plurality of biopharma production systems and machine networks. In some embodiments, the plurality of biopharma production systems comprise one or more bioreactors, chromatographies, and other electro-mechanical system that are required in biopharma manufacturing process. In some embodiments, the one or more machine learning algorithms are configured to analyze patterns in sensor outputs or signal characteristics from the biopharma production systems, wherein the sensor outputs or signal characteristics comprise, for example, one or more of the following: frequency, voltage, current, temperature, pressure, acoustics, system states, or images. In some embodiments, the images comprise at least one image or video of a product(s) or process(es) from one or more phases of a bioproduction cycle carried out using the biopharma production systems. In some embodiments, the product(s) comprise partially-manufactured products and/or fully-manufactured products. In some embodiments, the product(s) or process(es) from the one or more phases of the bioproduction cycle are associated with, for example, one or more of the following: inoculation, capture, seed cultivation, virus inactivation, cell culture, polishing, product recovery, or formulation. In some embodiments, the one or more machine learning algorithms are further configured to correlate the sensor outputs or signal characteristics to a set of input commands and/or instructions to the biopharma production systems, to determine whether the biopharma production systems are experiencing or likely to experience anomalies or behavioral deviations. In some embodiments, the set of input commands and/or instructions comprise (1) operator/user commands provided to production workstations or (2) Supervisory control and data acquisition (SCADA) or Distributed Control System (DCS) control commands that are sent to individual controllers of the biopharma production systems. In some embodiments, the one or more machine learning algorithms are further configured to detect whether the anomalies or behavioral deviations are due to (1) machine faults or issues occurring in the biopharma production systems and machine networks, (2) operator/user errors, (3) an external cyberattack on the biopharma production systems and machine networks, and/or (4) an internal cyber or physical attack on the biopharma production systems and machine networks. In some embodiments, the method further comprises generating one or more remedial recommendations or actions to localize, resolve or reduce an impact of the one or more cyber and/or physical anomalies on the biopharma environment. In some embodiments, the one or more remedial recommendations or actions include predictive maintenance, for example, on one or more of the biopharma production systems. In some embodiments, the method further comprises constructing a digital twin model of the biopharma environment based at least in part on the analyzed data from the one or more machine learning algorithms. In some embodiments, the digital twin model is implemented via a Platform as a Service (PaaS) and/or Software as a Service (SaaS). In some embodiments, the digital twin model can be configured to enable virtual simulation, analysis and/or optimization of the biopharma environment. In some embodiments, the digital twin model can be configured to enable remote operation or control of the biopharma environment. In some embodiments, the one or more machine learning algorithms can be initially trained in a cloud-based environment. In some embodiments, the one or more trained machine learning algorithms can be subsequently deployed on edge, and configured to run locally within the biopharma environment to generate inferences and perform quality assessment. In some embodiments, the one or more machine learning algorithms comprise a neural network and/or a clustering algorithm. In some embodiments, the method further comprises constructing a global model comprising of the (1) digital twin model of the biopharma environment and (2) at least one other digital twin model of another biopharma environment. In some embodiments, the global model can be trained in a distributed manner based on a federated learning framework.

According to another aspect, a method for modeling a biopharma environment is provided. The method comprises: obtaining and aggregating data from a plurality of sources within the biopharma environment, said bioreactor environment comprising at least one bioreactor system; providing bioreactor data from the aggregated data relating to one or more physical components of a bioreactor system to machine learning algorithms for training and analysis to generate a bioreactor system level model; providing cell data from the aggregated data relating to cell dynamics within the bioreactor system to machine learning algorithms for training and analysis to generate a bioreactor cell level model; providing fluidic data from the aggregated data relating to hydrodynamics or local fluidic phenomenon within the bioreactor system to machine learning algorithms for training and analysis to generate a bioreactor computational fluid dynamics model; and obtaining data from the bioreactor system level model, the bioreactor cell level model, and the bioreactor computational fluid dynamics model at a bioreactor hybrid model to generate one or more predictive values pertaining to the biopharma environment.

According to a further aspect, a method for calibration of a biopharma model is provided. The method comprises: accessing experimental data collected with aid of one or more physical instruments associated with a bioreactor system; analyzing the experimental data to generate (1) estimation data indicative of uncertainty, and (2) cross-validation data; performing a validation step of the biopharma model by comparing one or more predicted values from the biopharma model of the bioreactor system with the cross-validation data, wherein said comparison incorporates the estimation data; and reconfiguring the bioreactor system or the biopharma model with aid of a neural network or mechanistic correction, when an indication the biopharma calibration is not complete is provided, based on the comparison during the validation step.

Another aspect provides a non-transitory computer readable medium comprising machine executable code that, upon execution by one or more computer processors, implements any of the methods above or elsewhere herein.

Another aspect provides a system comprising one or more computer processors and computer memory coupled thereto. The computer memory comprises machine executable code that, upon execution by the one or more computer processors, implements any of the methods above or elsewhere herein.

Additional aspects and advantages of the disclosure will become readily apparent to those skilled in this art from the following detailed description, whereby illustrative embodiments are shown and described. As will be realized, the disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a diagram of an exemplary method for cyber and/or physical anomaly detection in a biopharma environment to support remedial actions, per one or more embodiments herein;

FIG. 2 shows a diagram of an exemplary method for cyber and/or physical anomaly detection in a biopharma environment to support remote operation or control, per one or more embodiments herein;

FIG. 3 shows a diagram of a global model and a plurality of digital twin models for controlling one or more biopharma environments, per one or more embodiments herein;

FIG. 4 shows a diagram of an exemplary physical structure, instrumentation, actuators and control methods used in a bioreactor system, per one or more embodiments herein;

FIG. 5A shows a diagram of an exemplary cyber and/or physical anomaly detection system, per one or more embodiments herein;

FIG. 5B shows a diagram of an exemplary biosecure digital twin system comprising a plurality of digital twins for different segments, per one or more embodiments herein;

FIG. 5C shows a Physical-to-Cloud connect architecture end-to-end model development process flow, per one or more embodiments herein;

FIG. 5D shows a detailed overview of the computational predictive modeling from FIG. 5C, per one or more embodiments herein;

FIG. 6 shows a diagram of an exemplary biosecure digital twin system using a federated learning framework, per one or more embodiments herein;

FIG. 7 shows a diagram of an exemplary learning and validation framework for a biopharma environment, per one or more embodiments herein;

FIG. 8A-1 shows a diagram of an exemplary process modeling framework for a bioreactor digital twin, per one or more embodiments herein;

FIG. 8A-2 shows a simulation output generated by the process modeling framework of FIG. 8A-1, per one or more embodiments herein;

FIG. 8B-1 illustrates a schematic diagram of a continuous biomanufacturing platform, per one or more embodiments herein;

FIG. 8B-2 illustrates a schematic diagram of a continuous biomanufacturing platform which uses spectroscopy systems and methods for process monitoring and control, per one or more embodiments herein;

FIG. 8B-3 illustrates a schematic diagram of various measurement modes (online, inline and atline), per one or more embodiments herein;

FIG. 8C illustrates a simulated model of the continuous manufacturing platform of FIG. 8B-1, per one or more embodiments herein;

FIG. 8D is a magnified view of the perfusion bioreactor model of FIG. 8C, including simulation results of the perfusion bioreactor model, per one or more embodiments herein;

FIG. 8E is a magnified view of the product capture model, viral inactivation model, and depth filtration model of FIG. 8C, including simulation results of each of the aforementioned models, per one or more embodiments herein;

FIG. 8F is a magnified view of the cation exchange (CEX) polish model and anion exchange (AEX) polish model of FIG. 8C, including simulation results of each of the aforementioned models, per one or more embodiments herein;

FIG. 8G is a magnified view of the nanofiltration model and single pass tangential flow filtration (SPTFF) model of FIG. 8C, including simulation results of each of the aforementioned models, per one or more embodiments herein;

FIG. 8H illustrates simulation results comparing the effects of temperature disturbance introduced into the perfusion bioreactor model versus normal operation conditions, per one or more embodiments herein;

FIG. 8I illustrates simulation results comparing the effects of load aggregate level disturbance introduced into the cation exchange (CEX) polish model versus normal operation conditions, per one or more embodiments herein;

FIG. 9 shows an example of a computational fluid dynamics (CFD) analysis of a dual-impellor system, per one or more embodiments herein;

FIG. 10 illustrates an overview of physical structure, instrumentation, actuators and control methods used in bioreactor control systems, per one or more embodiments herein;

FIG. 11A shows an example of a digital twin framework, per one or more embodiments herein;

FIG. 11B shows an example of a computational fluid dynamics (CFD) simulation analysis, per one or more embodiments herein;

FIG. 11C shows an example of a parameter kinetics analysis using a process system model, per one or more embodiments herein;

FIG. 11D shows model predictions of parameters, per one or more embodiments herein;

FIG. 11E shows statistical results of one factor at a time (OFAT), edge of failure, and process capability, per one or more embodiments herein;

FIG. 11F shows an example of a graphical user interface (GUI) of digital application platform, per one or more embodiments herein;

FIG. 12 shows model output for aggregation deviation, per one or more embodiments herein;

FIG. 13 shows an example of a digital shadow-assisted process validation framework for a Cation exchange chromatography (CEX) unit operation, per one or more embodiments herein;

FIG. 14 shows an example of a workflow for digital shadow development shown for a Cation exchange chromatography (CEX) unit operation, per one or more embodiments herein;

FIG. 15 shows an example of a digital shadow-assisted process characterization platform, per one or more embodiments herein;

FIG. 16 shows an example of a digital twin deployment infrastructure, per one or more embodiments herein;

FIG. 17 shows a non-limiting example of a computing device; in this case, a device with one or more processors, memory, storage, and a network interface;

FIG. 18 shows a non-limiting example of a web/mobile application provision system; in this case, a system providing browser-based and/or native mobile user interfaces; and

FIG. 19 shows a non-limiting example of a cloud-based web/mobile application provision system; in this case, a system comprising an elastically load balanced, auto-scaling web server and application server resources as well synchronously replicated databases.

### DETAILED DESCRIPTION

Provided herein are cyber and/or physical anomaly detection systems and methods that employ a biosecure digital twin to provide a high-fidelity virtual copy of a changing biopharma research and manufacturing environment. Cyber anomaly (or anomalies) may be attributable to cyber vulnerabilities and/or cybersecurity risks in the systems and networks employed in a biopharma research and manufacturing environment. For example, one or more components of the systems and networks may be vulnerable or open to attack by various cyber threats, such as viruses, malware, or hackers. The cyber threats may present risks of data loss, privacy intrusions, or intellectual property (e.g. proprietary formulations, processes and recipes) theft or misappropriation, which may affect the information technologies (IT) and operations of the biopharma environment. Physical anomaly (or anomalies) may be associated with machines and processes that are operated/executed in the biopharma environment, and may be attributable to machine failure, human errors, inadvertent/mistaken operations or incorrect recipe settings, lot contamination, process deviations and the like. In certain instances, a physical anomaly may be caused by a cyber-attack, for example a hacker taking remote control of one or more systems or processes in the biopharma environment, and performing malicious activities.

The systems and methods disclosed herein can improve modeling, analytics, quality, and security of biopharma production systems, which often display high levels of stochasticity, entropy, and non-orthogonal deviations. Thousands of hours of production data may be required to determine the steady state of a stochastic environment such as the production batch process. While advances in sensor technology and cybersecurity network monitoring have helped improve awareness of machine state integrity, data garnered from current systems is often insufficient to form high-fidelity system models and simulations. The use of the models and simulations (via one or more biosecure digital twins) disclosed herein can enable detection and localization of zero-day cyber-attacks, machine degradation, and operator faults that may adversely affect machine state integrity and quality. The methods and systems herein employ machine learning for improved anomaly detection, whereby cyber physical processes and features that measure quality and machine state integrity can be classified through batch characterization processes using machine learning.

The high fidelity modeling bioproduction systems herein can enable improved telemetry of networks, process-oriented production system physics, and various process signals and cognitive behavioral signals. Process signals may be associated with physical and/or chemical processes that are occurring in the machines/systems (e.g., bioreactors) in the biopharma environment. Cognitive behavioral signals may be associated with behaviors exhibited by human operators or personnel as they operate the machines/systems in the biopharma environment. As described herein, data can be collected, aggregated, analyzed and classified to train machine learning algorithms for anomaly detection, localization and process optimization or improvement. Continuous training of the machine learning algorithms can improve digital twin modeling and ability to monitor, detect, localize, and neutralize any machine state changes that may cause security, safety and/or quality deviations.

The methods and systems herein can enable scalable, efficient, modular, and compliant (e.g., US Department of Defense (DoD), Food and Drug Administration (FDA)) threat identification and medical countermeasure (MCM) delivery, in addition to providing improvements in manufacturing process control, computational modeling, and small/large molecule drug development (e.g., monoclonal antibodies, vaccines, enzymes). The methods and systems herein can improve the speed and quality of the drug development cycle by reducing risk and the necessity for experimental exploration. The methods and systems herein can combine process-oriented physics and networking digital twinning with biological modeling to improve bio-manufacturing. Such methods can also be employed, for example to provide predictive maintenance and improve medical countermeasure (MCM) development and delivery during crises (such as tackling of pandemics).

The following describes the employment of a biosecure digital twin with a cloud reference architecture for continuous monitoring of machine state integrity and quality.

### Cyber and Physical Anomaly Detection in a Biopharma Environment

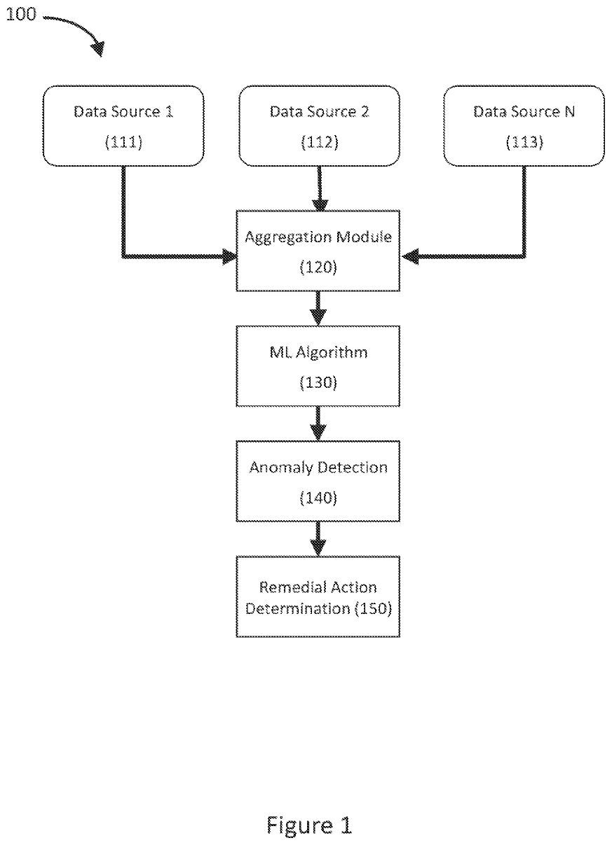

FIGS. 1-3 show diagrams of exemplary methods for cyber and/or physical anomaly detection in a biopharma environment. Provided herein, per FIGS. 1-3 are methods for cyber and/or physical anomaly detection 100 in a biopharmaceutical research and/or manufacturing (biopharma) environment. As shown in FIG. 1, method 100 may comprise obtaining data from a plurality (N) of data sources 111 112 113 within a biopharma environment, whereby N is any integer greater than one, and aggregating the data sources 111 112 113 by an aggregation module 120. The method 100 may further comprise providing the aggregated data to one or more machine learning algorithms 130 for training and analysis; and using the one or more trained machine learning algorithms to detect, identify or predict one or more cyber and/or physical anomalies 140 that have occurred, are occurring, or are likely to occur within the biopharma environment. The method 100 may also further comprise generating one or more remedial recommendations or actions 150 to localize, resolve or reduce an impact of the one or more cyber and/or physical anomalies on the biopharma environment. The one or more remedial recommendations or actions 150 may include performing predictive maintenance, for example, on one or more of biopharma production systems or machine networks in the biopharma environment.

In some embodiments, the plurality of data sources 111 112 113 may comprise a plurality of biopharma production systems and machine networks. The data received from the plurality of sources may comprise telemetric data and metadata associated with the plurality of biopharma production systems and machine networks.

The data may be aggregated by the data aggregation module 120. In some embodiments, the data aggregation module 120 can be configured to automatically synchronize the telemetric data across the plurality of biopharma production systems and machine networks. The automatic synchronization of the telemetric data may be performed in real-time, at fixed time intervals, or at random time intervals. In some cases, the data aggregation module 120 can be configured to extract the metadata from the plurality of biopharma production systems and machine networks.

In some embodiments, the one or more machine learning algorithms 130 can be configured to analyze patterns in sensor outputs or signal characteristics from the biopharma production systems. In some embodiments, the plurality of biopharma production systems may comprise one or more bioreactors. The sensor outputs or signal characteristics may include sensor data, time-series data, structured data, unstructured data, relational data, or any other type of data associated with the one or more bioreactors. In some embodiments, the one or more machine learning algorithms 130 can be further configured to correlate sensor outputs or signal characteristics to a set of input commands and/or instructions to the biopharma production systems, to determine whether the biopharma production systems are experiencing or likely are to experience anomalies or behavioral deviations. The set of input commands and/or instructions may comprise operator/user commands provided to production workstations. The set of input commands and/or instructions may further or alternatively comprise, for example, supervisory control and data acquisition (SCADA) or Distributed Control System (DCS) control commands that are sent to individual controllers of the biopharma production systems. In some embodiments, the one or more machine learning algorithms 130 can be further configured to detect whether the anomalies or behavioral deviations 140 are due to machine faults or issues occurring in the biopharma production systems and machine networks. The one or more machine learning algorithms 130 may be further configured to detect whether the anomalies or behavioral deviations are due to operator/user errors. In some embodiments, the one or more machine learning algorithms 130 can be further configured to detect whether the anomalies or behavioral deviations are due to an external cyberattack on the biopharma production systems and machine networks.

The remedial action 150 may comprise a firewall, network segmentation, access control, remote access virtual private networks (VPN), zero trust network access (ZTNA), email security, data loss prevention (DLP), intrusion prevention systems (IPS), sandboxing, hyperscale network security (HNS), and cloud network security. Firewalls can control incoming and outgoing traffic on networks, with predetermined security rules that keep out unfriendly traffic. Network segmentation can define boundaries between network segments where assets within the group have a common function, risk or role within an organization. Access control may define people or groups and/or their devices that have access to network applications and systems thereby denying unsanctioned access. Remote access VPN can provide remote and secure access to a network to individual hosts or clients. The ZTNA trust security model may ensure that a user should only have the access and permissions that they require to fulfill their role. Email security may refer to processes, products, and services designed to protect email accounts and email content safe from external threats. DLP is a cybersecurity methodology that can combine technology and best practices to prevent the exposure of sensitive information outside of an organization, especially regulated data such as personally identifiable information (PII) and compliance related data. IPS technologies can detect or prevent network security attacks such as brute force attacks, Denial of Service (DoS) attacks and exploits of known vulnerabilities. Sandboxing is a cybersecurity practice where code is executed or files opened in a safe, isolated environment on a host machine that mimics end-user operating environments. Sandboxing may observe the files or code as they are opened and looks for malicious behavior to prevent threats from getting on the network. HNS tightly integrates networking and computing resources in a software-defined system, to fully utilize all hardware resources available in a clustering solution. In cloud network security, applications and workloads may be stored one a plurality of distributed computers to reduce the risks associated with data centers.

In some embodiments, the sensor outputs or signal characteristics may comprise, for example, one or more of a frequency, voltage, temperature, pressure, acoustics or images from or associated with the biopharma production systems. In some embodiments, the images may comprise at least one image or video of a product(s) or process(es) from one or more phases of a bioproduction cycle carried out using the biopharma production systems. The product(s) may comprise partially-manufactured products and/or fully-manufactured products. In some embodiments, the product(s) or process(es) from the one or more phases of the bioproduction cycle may be associated, for example, with one or more of the following: inoculation, capture, seed cultivation, virus inactivation, cell culture, polishing, product recovery, or formulation.

### Digital Twin Models

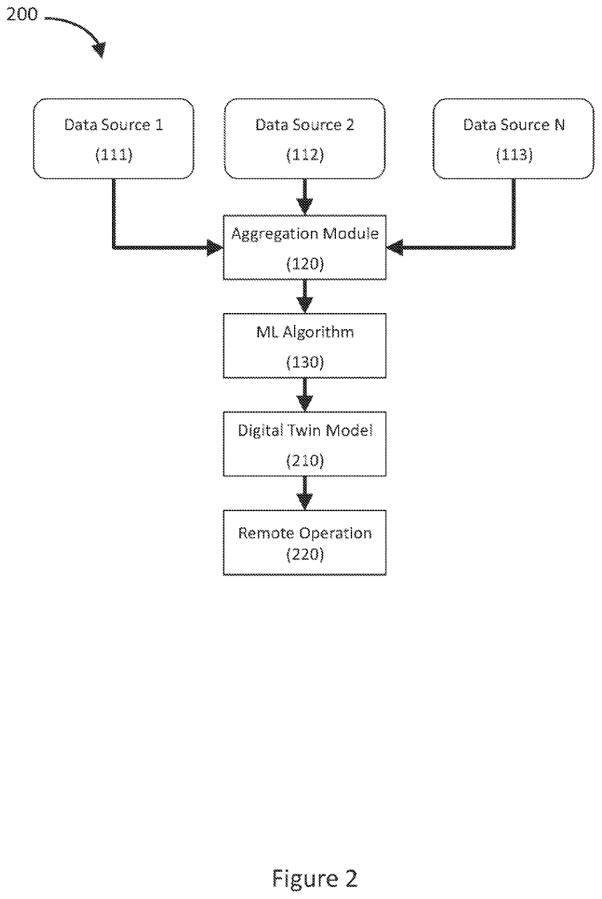

FIG. 2 illustrates an exemplary method of constructing a digital twin model 210 of a biopharma environment based at least in part on analyzed data from the one or more machine learning algorithms 130. In some embodiments, the digital twin model 210 may be implemented via a Platform as a Service (PaaS) or Software as a Service (Saas). In some embodiments, the digital twin model 210 can be configured to enable virtual simulation, analysis and/or optimization of the biopharma environment. The digital twin model 210 can also be configured to enable remote operation or control 220 of the biopharma environment.

Referring to FIG. 2, in some embodiments, the one or more machine learning algorithms 130 may be initially trained in a cloud-based environment. In some embodiments, the one or more trained machine learning algorithms 130 may be subsequently deployed on edge, and configured to run locally within the biopharma environment to generate inferences and perform quality assessment. In some embodiments, the one or more machine learning algorithms 130 may comprise a neural network and/or a clustering algorithm.

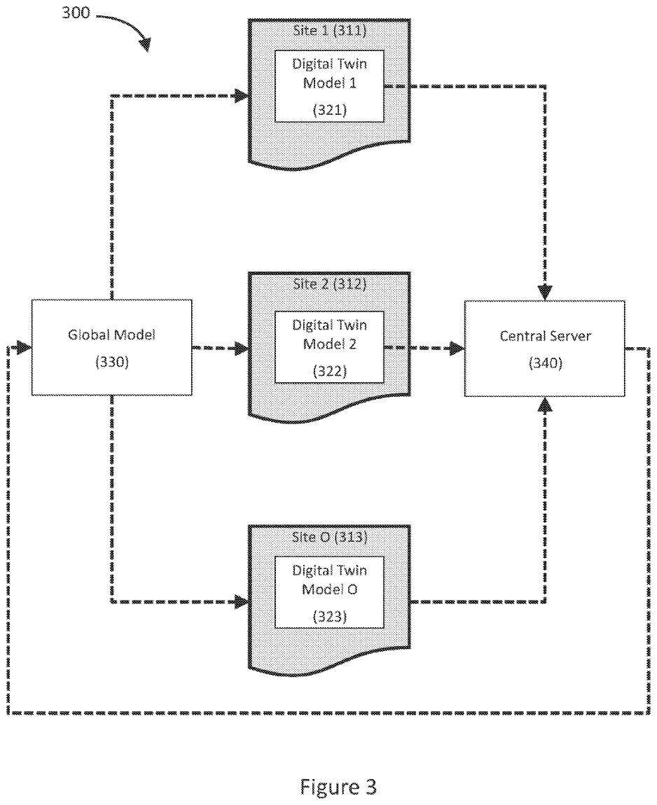

In some embodiments, per FIG. 3, the method 300 further comprises constructing and utilizing a global model 330 that is in communication with a first digital twin model 321 of a first biopharma environment located at a first site 311 and a second digital twin model 322 of a second biopharma environment located at a second site 321. In some embodiments, the global model 330 may be in communication with one or more other digital twin models O (323) of additional biopharma environments located at other sites 313. In some embodiments, the global model 330 may be trained in a distributed manner based on a federated learning framework. In some embodiments, distributed training may comprise utilizing a training workload that is split across multiple processors. The processors may be in a same geographic location, or located in different geographic locations. In some embodiments, the global model 330 can transmit global model parameters, for example, to one or more of the digital twin models 321 322 323. The global model parameters may include, for example, machine and/or process conditions that can be replicated or implemented across different digital twin models. The digital twin models 321 322 323 are in communication with a central server 340, and can be configured to transmit data (e.g. machine and/or process conditions occurring in each biopharma environment) to the central server 340. The central server 340 can be configured to aggregate the data from the digital twin models 321 322 323, and transmit the aggregated data in a feedback loop back for training the global model 330. The global model 330 can be improved with continuous training, which can improve a precision or accuracy of the global parameters that are transmitted to the digital twin models 321 322 323.

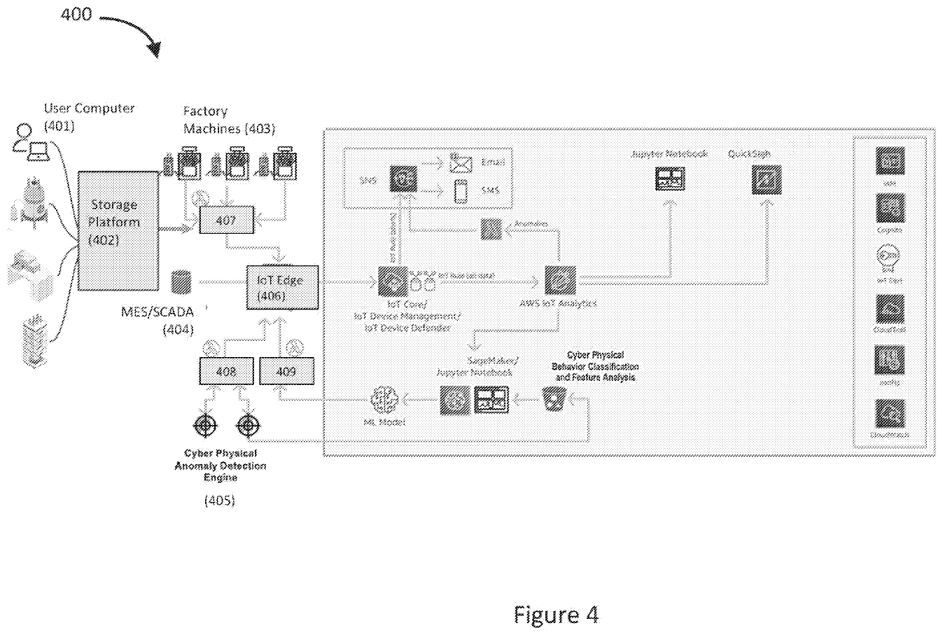

FIG. 4 shows a diagram of an exemplary physical structure, instrumentation, actuators and control methods used in a bioreactor system 400 (or any system used in bioproduction). As shown, system components 401 (e.g., bioreactors, control systems, and communication systems) may provide metadata for analysis by a synchronized storage platform 402 (e.g., DarwinSync), which in addition to data from factory machines 403, forms a first protocol conversion 407 that is transmitted to an Internet of Things (IoT) edge 406 (i.e., IoT Greengrass). The first protocol conversion 407 may include a set of instructions or rules for transforming, normalizing or pre-processing the metadata and the data. The IoT edge 406 can be configured to further receive Manufacturing Execution System (MES) and/or Supervisory Control And Data Acquisition (SCADA) or Distributed Control System (DCS) or Historian data 404, a machine learning interference 409, and a second protocol conversion 408 from a cyber physical anomaly detection engine 405. The second protocol conversion 408 may include a set of instructions or rules for transforming, normalizing or pre-processing the SCADA data. In some embodiments, the IoT edge 406 can ingest inputs from sensor suites, perform the required protocol translation, and run a machine learning inference. The cyber physical anomaly detection engine 405 can aggregate and learn from telemetry and metadata collected from the production systems. The architecture shown in FIG. 4 can improve predictive quality analytics by providing actionable insights on machine state integrity. For example, a complexity of the sensor suite, the suite's relationship with the SCADA commands and the physical process output governed by SCADA control commands can create pattern that are capable of being extracted using various machine learning algorithms. An exemplary machine learning algorithm for cyber physical anomaly detection may measure and correlate physical outputs (e.g., frequency, voltage, ambient) with anomalies or behavioral deviations that are unlikely to have resulted from certain digital commands and/or functions. In some instances, Extreme Learning Machine can further delineate near boundary conditions and more accurately classify faults versus attacks, to improve detection accuracy and reduce false positives. For example, Extreme Learning Machine can improve detection accuracy by at least about 1%, 2%, 5%, 10%, 15%, 20%, 25%, 30%, 40%, 50%, or more including any increments therebetween. Extreme Learning Machine can also reduce false positives by at least about 1%, 2%, 5%, 10%, 15%, 20%, 25%, 30%, 40%, 50%, or more including any increments therebetween.

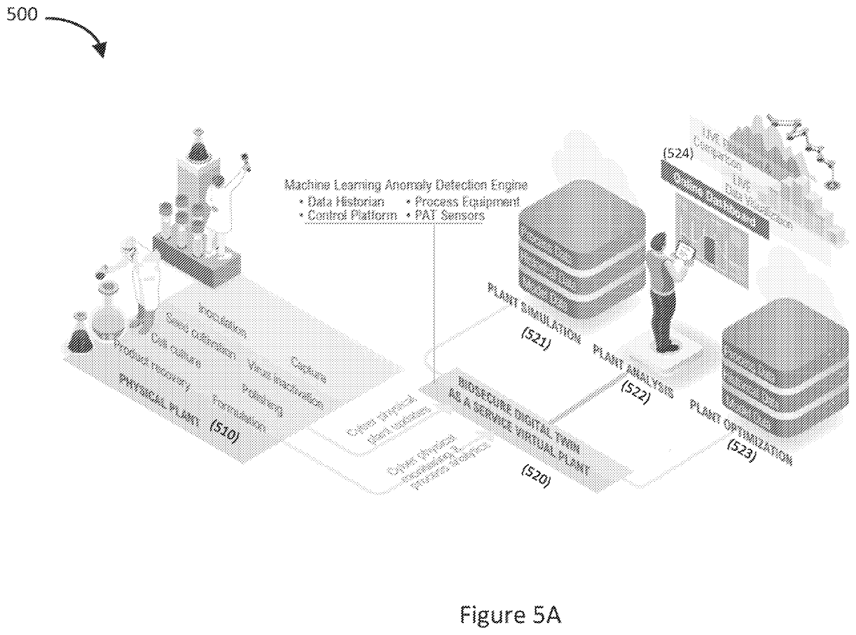

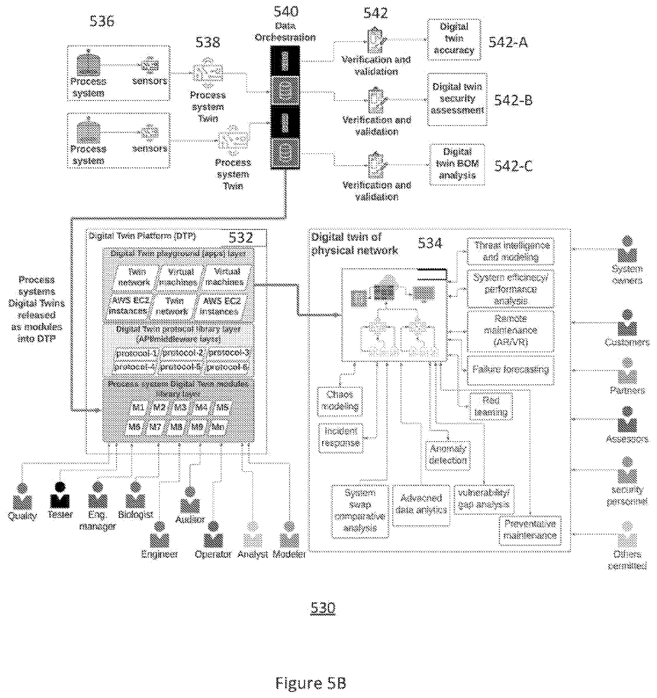

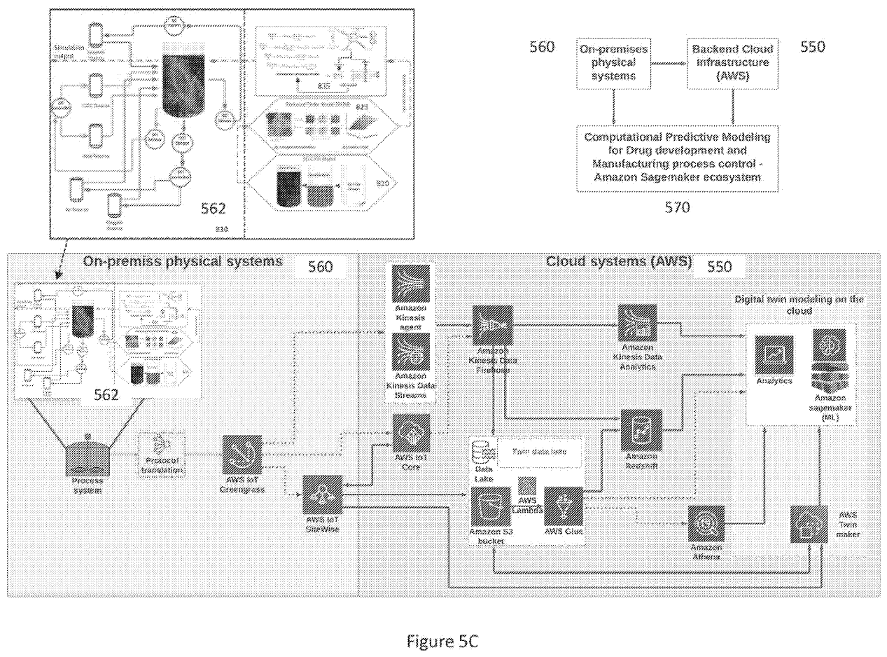

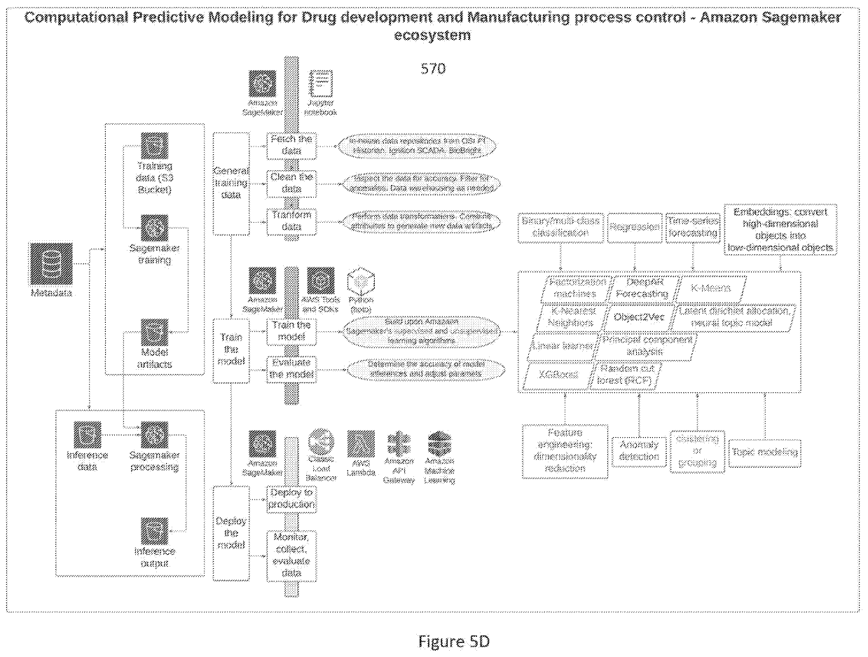

FIG. 5A shows a diagram of an exemplary cyber and/or physical anomaly detection system 500 that employs a biosecure digital twin 520 to improve modeling, simulation and monitoring of machine state integrity, security, safety, and quality. As shown, a physical plant 510 configured for inoculation, capture, seed cultivation, virus inactivation, cell culture, polishing, product recovery, formulations, or any combination thereof or any other application, can provide cyber physical plant updates and cyber physical monitoring and process analytics to a biosecure digital twin 520. The biosecure digital twin 520 can enable plant simulation 521 and plant optimization 523 using process, historical, and model data, and allow one or more users to perform plant analysis 522 using a graphical interactive dashboard 524. Examples of users may include system operators, engineers, maintenance planners, field technicians, and managers. The graphical interactive dashboard 524 can be used to support day-to-day operations, including remote configuration changes, field inspections or audits, and periodic analyses of overall system performance within the biopharma environment.

The biosecure digital twin can comprise a machine learning anomaly detection engine which is configured to receive historical data processing equipment control and Process Analytical Technology (PAT) sensor data. Anomalies can be caused by numerous factors and thus detection alone is often insufficient to correct such errors. To prevent prohibitive false positives and improve actionable and predictive insight, the behavior behind the anomalies can be determined and localized to perform remedial action in more predictive way, to thereby improve the integrity and continuous quality of a biopharma manufacturing space. Anomaly detection may employ metadata pulled from production systems (e.g., BioBright's Darwin Sync™, Amazon Web Services (AWS) IoT™, Greengrass™, and Sage Maker™) to build a predictive quality model. A machine learning model can perform inferential correlation of the metadata and related signals from manufacturing equipment, such as ambient condition measurements, frequency, voltage, acoustics or observations from human operators. A physical anomaly detection algorithm can enable continuous and predictive quality monitoring by predicting failures (e.g., predictive maintenance). The physical anomaly detection algorithm may employ computer vision in its machine learning process. In some embodiments, the physical anomaly detection algorithm can perform inferential correlation of received metadata and related signals from manufacturing equipment. The machine learning anomaly detection engine may in some instances function as a data historian, and may control the platform, process equipment, and/or PAT sensors.

The metadata may comprise images, ambient conditions, frequency, voltage or observations from human operators. The IoT edge can ingest inputs from sensor suites, perform the required protocol translation, and run machine learning inference. Once data (e.g., frequency, voltage, ambient, images, videos) has been uploaded to the IoT edge, classification and features sets can be assigned to train a machine learning model appropriate to the product output. A machine learning model deployed in the IoT edge may detect anomalies in machine state integrity as well as associated outputs, such as faulty products. The machine learning model deployed in the IoT edge can be run locally, enabling continuous operation regardless of internet connectivity. The IoT edge and the physical anomaly detection engine may feed into a cloud machine-learning platform (e.g., Amazon SageMaker™) which labels and prepares data, chooses an algorithm, trains the model, tunes and optimize the models, and provides output instructions accordingly. The cloud machine-learning platform can directly apply an algorithm to clean data that has been processed by an IoT inventory management system (e.g., AWS IoT Analytics™). In some embodiments, the algorithm can enable statistical classification through logistic regression. In some instances, the algorithm may be Long-Short-Term Memory (LSTM) which is a neural network that can be used to predict the output or change in machine state integrity over time. In other instances, pre-built notebook templates may support a K-means clustering algorithm for device segmentation, for improved device health and device state integrity. In some embodiments, any of the machine learning algorithms herein can be configured to focus on identification and detection with improvements in learning and accuracy of detection and localization. In some embodiments, any of the algorithms herein may be extended to neutralization of deviation behavior and corrective response to return to machine state integrity and/or associated quality.

Collecting biological scale-up process data can enable a new level of data-driven digital biosecurity monitoring. At scale (e.g., recording data from hundreds or thousands of machines), a process employing an Application Programming Interface (API) and structured data can be used to form an improved computational model for process identification and characterization to improve integrity, safety, and security of a biopharma environment. The algorithms herein can alert an asset operator of process faults to improve orchestration, visualization and control of small/large molecule drug development and manufacturing processes model data.

Computational modeling associated with the manufacturing process using process-oriented digital twins, for example various biomanufacturing processes described herein, can enable high fidelity dynamic modeling, optimization and security to advance and optimize the drug development process. The digital twins can enhance the quality analysis process, security, resiliency, and safety parameters, without compromising any of the aforementioned.

FIG. 5B shows a diagram of an exemplary biosecure digital twin system 530 comprising a plurality of digital twins (twins directed to different segments). For example, the digital twin system 530 can comprise a digital twin platform (DTP) 532 of manufacturing systems within a biomanufacturing platform. Those manufacturing systems may include electromechanical systems, chemical systems and the like. The digital twin system 530 can further comprise a digital twin 534 of a physical network of the manufacturing systems connected or interconnected to one another. The digital twin 534 can be used for end-to-end manufacturing modeling and analysis.

The two digital twin segments (one for systems, and the other for network) in FIG. 5B may have different levels of data requirements and granularity, and one segment may be used to accommodate varying accuracies (or inaccuracies) of the other segment. Accordingly, implementation of digital twins for different segments can aid in making the overall biosecure digital twin system 530 more robust. For instance, to perform precise threat modeling and vulnerability analysis, or implement methods from chaos engineering on a particular bioreactor, the accuracy of the predictive outcomes is in most cases proportional to the accuracy of the digital twin of the bioreactor itself. In contrast, the requirement of having a high-fidelity bioreactor model may be less important when performing a similar threat and vulnerability analysis on a network (e.g. an Industrial Control Systems (ICS) network) comprising multiple systems (whereby a single bioreactor is merely a system among numerous other systems). In other words, the effect of a bioreactor within a network of tens, hundreds or thousands of other system can become much less relevant, depending on the type of analysis or outcome that is being modeled. When performing a threat and vulnerability analysis on the network, the granularity of the network model tends to be of high importance, especially relating to protocol modeling, data packet replication, network behavior, data sampling models, etc. The biosecure digital twin system 530 in FIG. 5B can allow users to pivot in multiple directions and simultaneously run digital twins of the systems 532 and network 534 as needed depending on the target application(s) or use case(s).

In order to construct the biosecure digital twin system 530, specifications or information pertaining to biomanufacturing systems 536 on the platform is first obtained from a plurality of sources, for example systems manufacturers, engineers, process technicians and the like. The biomanufacturing systems 536 may include a plurality of process systems operably coupled to a plurality of sensors. A plurality of process system twins 538 can be generated based on the specifications or information pertaining to the biomanufacturing systems 536, along with datasets associated with those systems. The process system twins 538 may comprise a plurality of models. The models and the datasets are subsequently provided to a data orchestration unit 540 for aggregation, before undergoing verification and validation 542, for example to ensure that the models and datasets are accurate 542-A, that security of the datasets are intact (i.e. ensuring integrity of the datasets) and that the models do not have any gaps 542-B, and performing a bill of material (BOM) analysis 542-C of the models in correlation with their respective hardware.

Upon successful verification and validation 542 of the datasets, the data orchestration unit 540 will release the models as modules (as well as the accompanying datasets) to the Digital Twin Platform (DTP) 532. The DTP 532 may comprise a plurality of segments or layers, for example (1) a Digital Twin modules library layer, (2) a Digital Twin protocol library layer (API/middleware layer), and (3) a Digital Twin playground (applications) layer. The Digital Twin modules library layer comprises all of the processed digital twin models (e.g. M1 through Mn) and their pertinent datasets. Depending on the access controls in place, organizational entities, as well as collaborative vendor (e.g. non-organizational or cross-organizational) entities can have access to the Digital Twin modules library layer, which ensures proper staging of the models for consumption/use for various cases.

Multiple communication protocols can be used to enable data exchange between individual subsystems or systems. These real-world protocols are represented in the protocol library/API/middleware layer (e.g. as protocol-1 through protocol-6). A communication protocol can be selected based on a type of twin model. The twin models can use their respective real-world protocol representations from the DTP 532 to ensure accurate representation of real-world communications.

The Digital Twin playground (applications) layer can be a sandbox layer comprising one or more Platform as a service (PaaS) or Software as a service (SaaS) related infrastructure, which may include virtual machines (VMs), twin networks, Elastic Compute Cloud (EC2) instances, and the like, that enable end-users to perform analysis using the digital twin models. The individual models (e.g. any of M1 through Mn) and protocols (e.g. any of protocol-1 through protocol-6) from the lower layers can be used either as stand-alone for system-level studies, or any of those models and protocols can be networked together in the playground application layer for network-level and other system-of-system dynamics analysis. FIG. 5C illustrates a PaaS/SaaS/cloud infrastructure 550 that can be used to architect the DTP 532 and other components. While the infrastructure 550 in FIG. 5C is based on an AWS infrastructure, it should be noted that the DTP 532 is cloud solution agnostic, and that similar components of any other cloud service providers such as Microsoft Azure and Google cloud can be used in a similar fashion to implement DTP 532.

Referring back to FIG. 5B, the digital twin 534 of the physical network illustrates an example of a complex digital twin system-of-systems network and system model, showing networked or connected views of multiple individual digital twin models of the systems (e.g. electro-mechanical systems, chemical systems, etc.) of a manufacturing process. Various entities use-cases and studies can be performed using the digital twin 534 of the physical network, which may include one or more of the following: 1) Cyber threat intelligence and modeling studies, 2) System efficiency & performance analysis, 3) Workforce training through AR/VR or other computerized methods, 4) System or network failure forecasting/prediction, 5) Real-time red teaming studies including methods from penetration testing and chaos modeling, 6) Evaluation of preventative maintenance cycles & system/network impact of performing preventative maintenance, 7) Cyber and physical vulnerability/gap analysis, 8) Anomaly detection, 9) Disaster recovery and incident response table top exercises and prediction-driven response studies, 10) Advanced data analytics for manufacturing & automation optimization, 11) Chaos modeling to implement proactive resiliency measures without system or network degradation, 12) System swap comparative analysis & impact analysis on the manufacturing process, and 13) biological & chemical modeling/parameter estimation. The results or outcomes of the various use-cases or studies can serve a variety of target entities, for example one or more of the following: system owners, investors, customers, partners, assessors, security personnel, biologists, computational modelers, process instrumentation engineers, data scientists, quality personnel, automation personnel, manufacturing personnel, etc. Access control to the models and datasets in DTP 532, and data outputs from digital twin 534, can be established based on end-user/consumer/customer requirements and duties. In some cases, need-to-know principles can be implemented using zero-trust or trust-but-verify methods.

A combination of on-premises and cloud infrastructure can be used to execute the DTP methodology herein to develop computational models, digital twins, and the relevant machine learning (ML) algorithms. Cloud solutions can offer multiple out-of-the-box cloud artifacts to streamline data storage and analysis; model development and testing; digital twin execution and validation; and machine learning algorithm development, training, and deployment. Using AWS as an example cloud solution, the architecture and design process can involve leveraging AWS artifacts such as AWS Sagemaker for algorithm development, AWS twin maker for digital twin development, AWS data lake and S3 buckets for data storage and processing, AWS data analytics and SDK toolkits for building applications to automate the digital twin execution and to consume the digital twin model outcomes. Similar or equivalent artifacts from Microsoft Azure, Google Cloud or other cloud providers can also be configured or used to implement the above. Computational models can be designed by leveraging cloud artifacts such as AWS's backend infrastructure to enable scalability and interoperability with any current future biopharma manufacturing systems or processes.

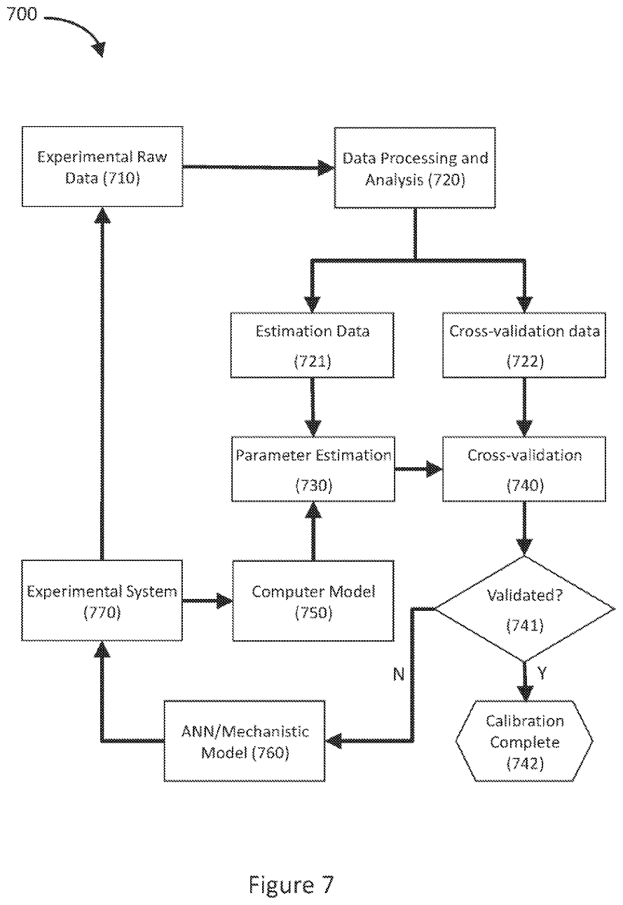

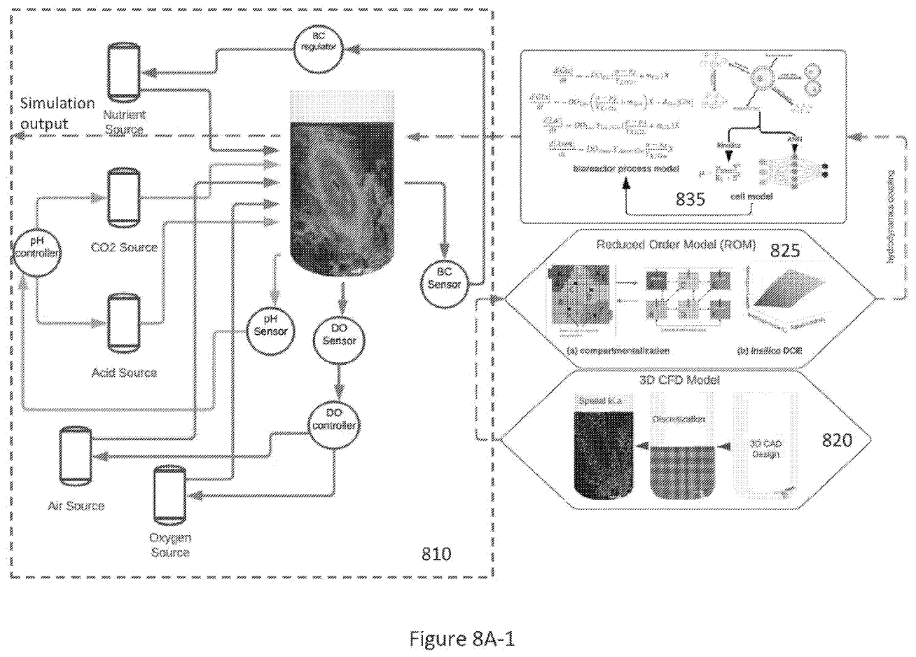

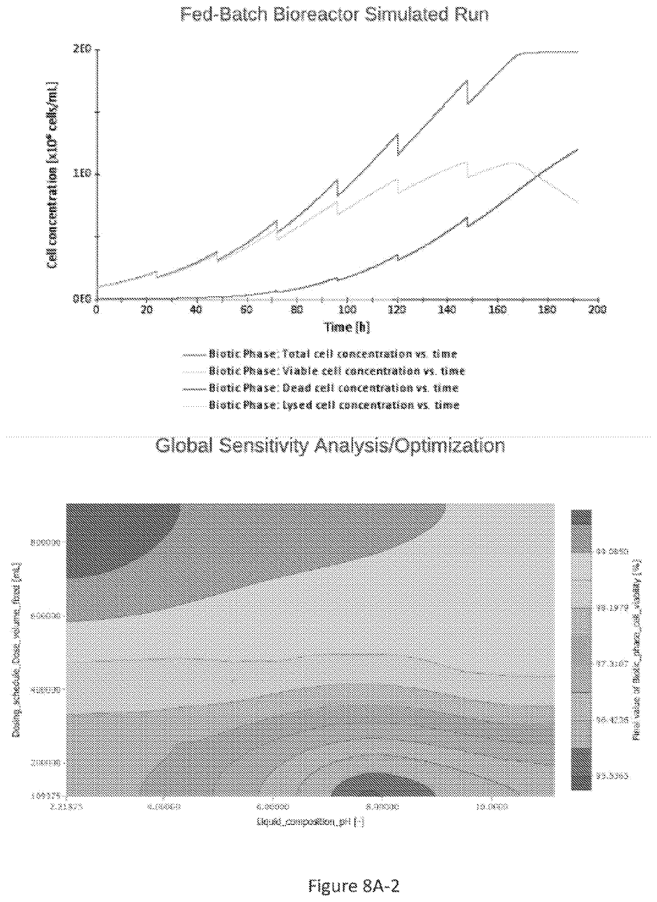

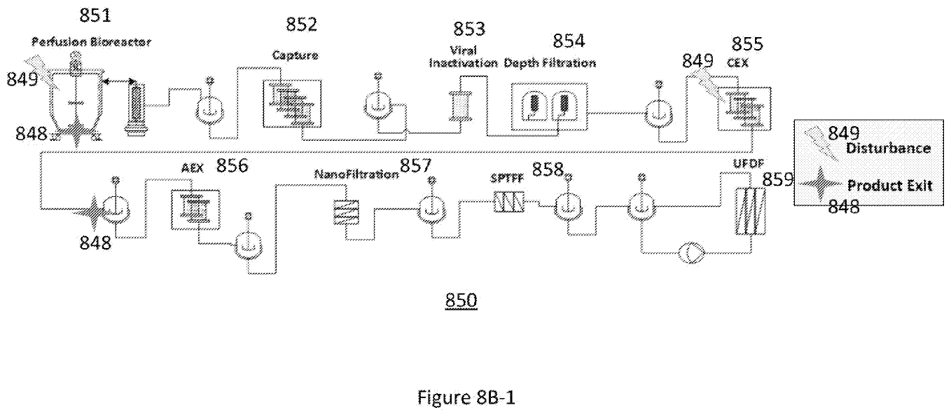

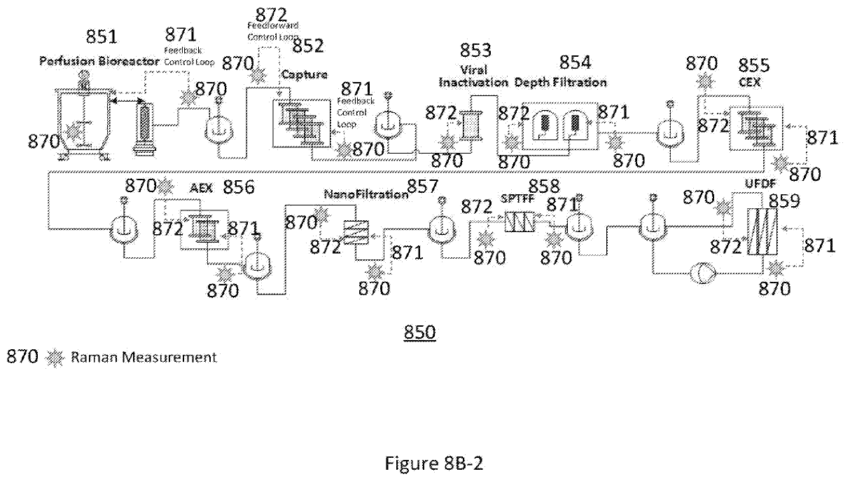

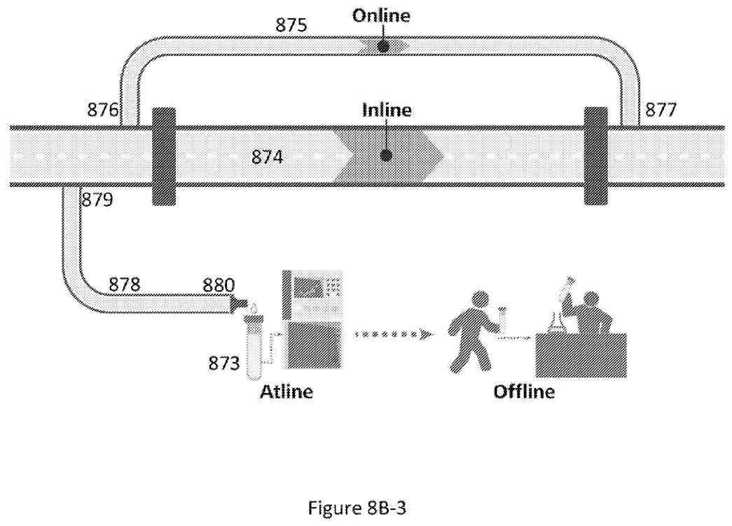

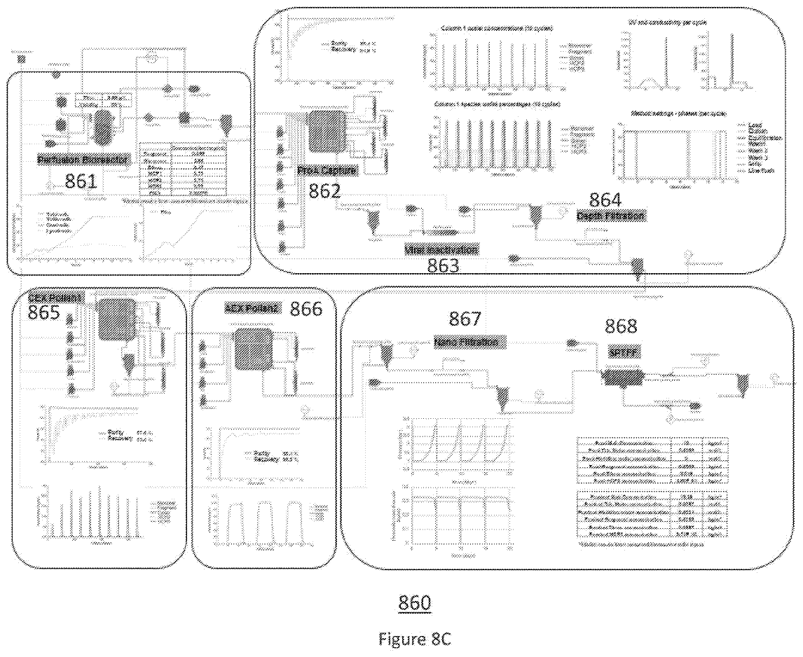

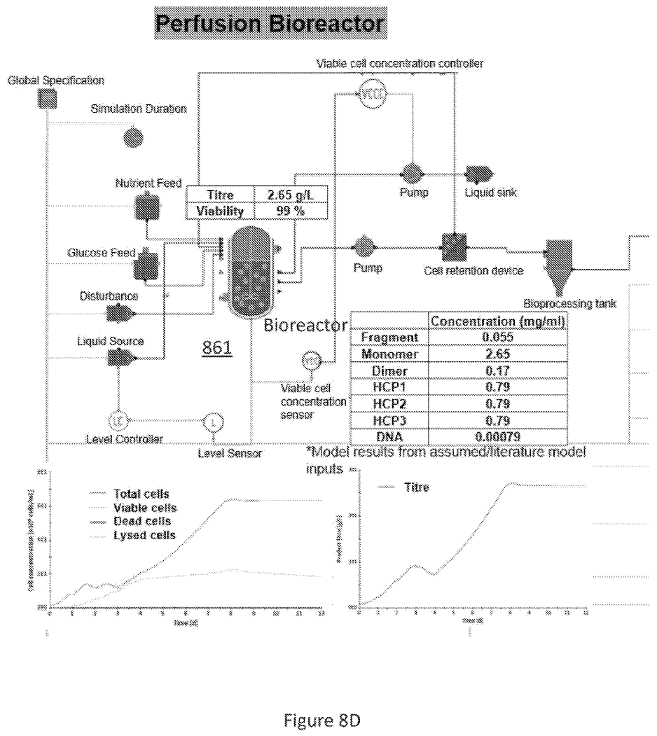

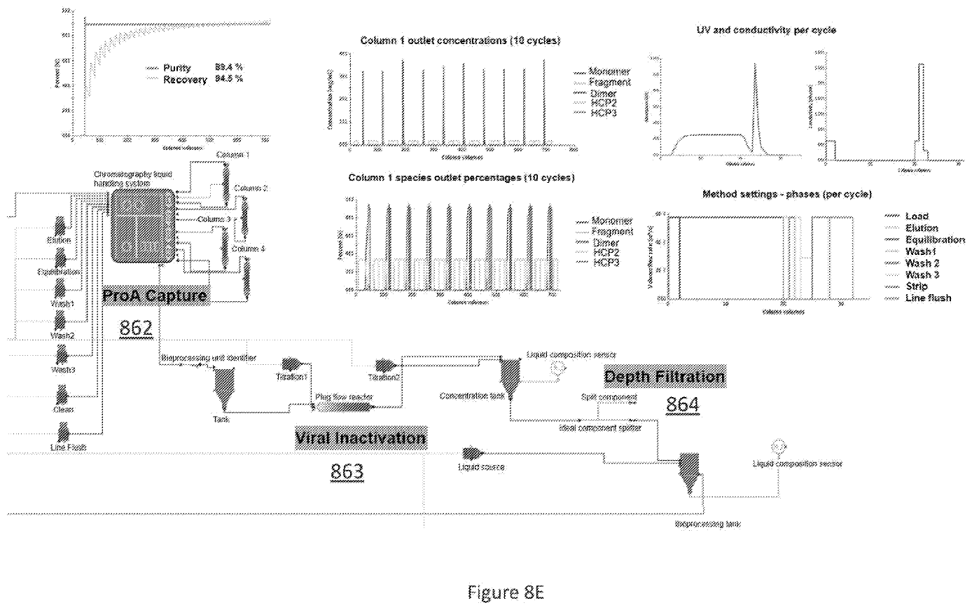

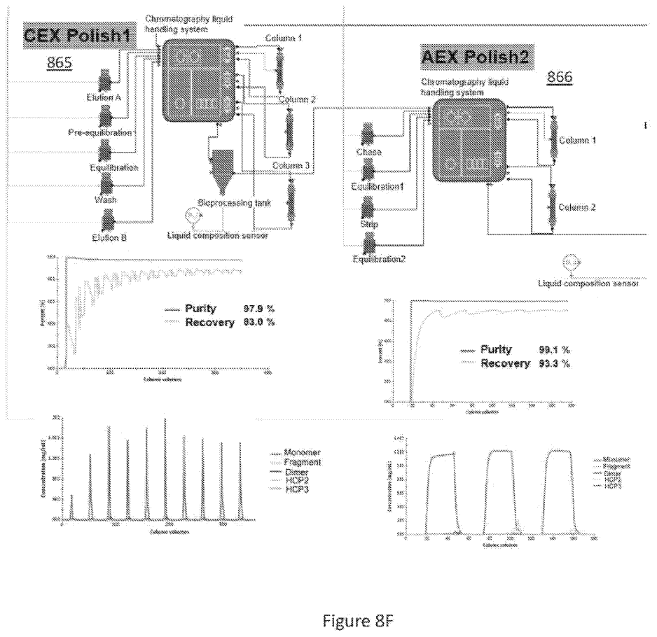

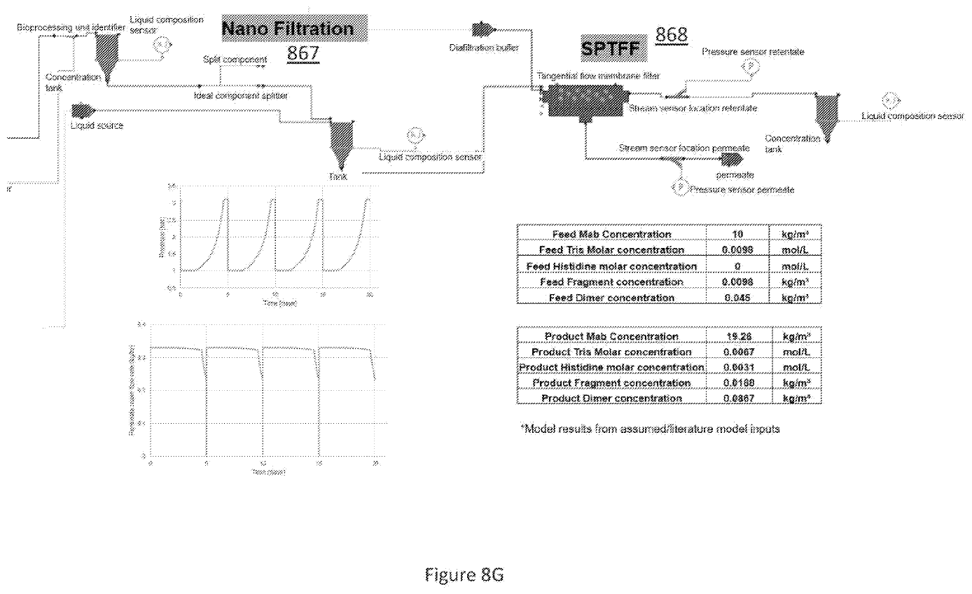

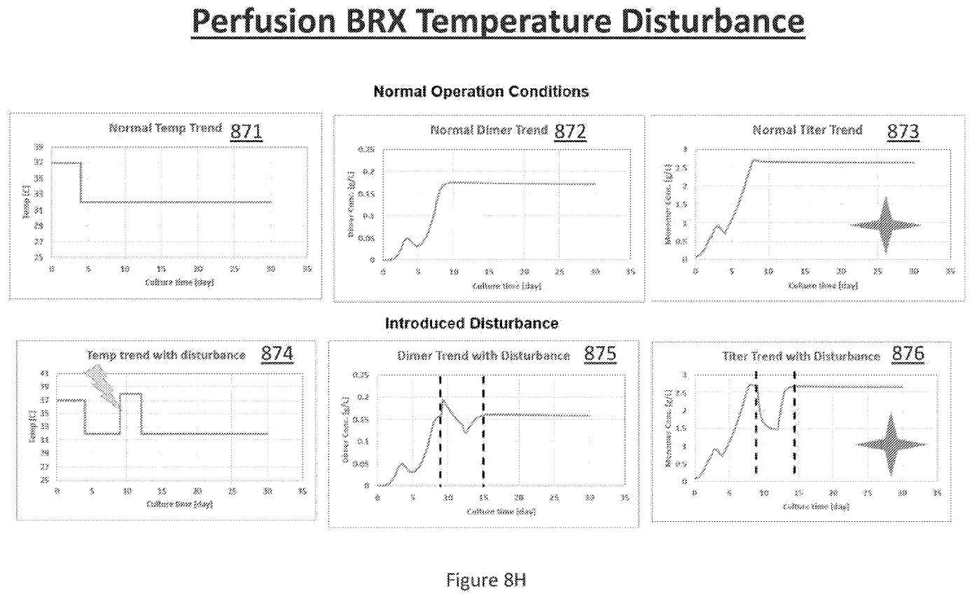

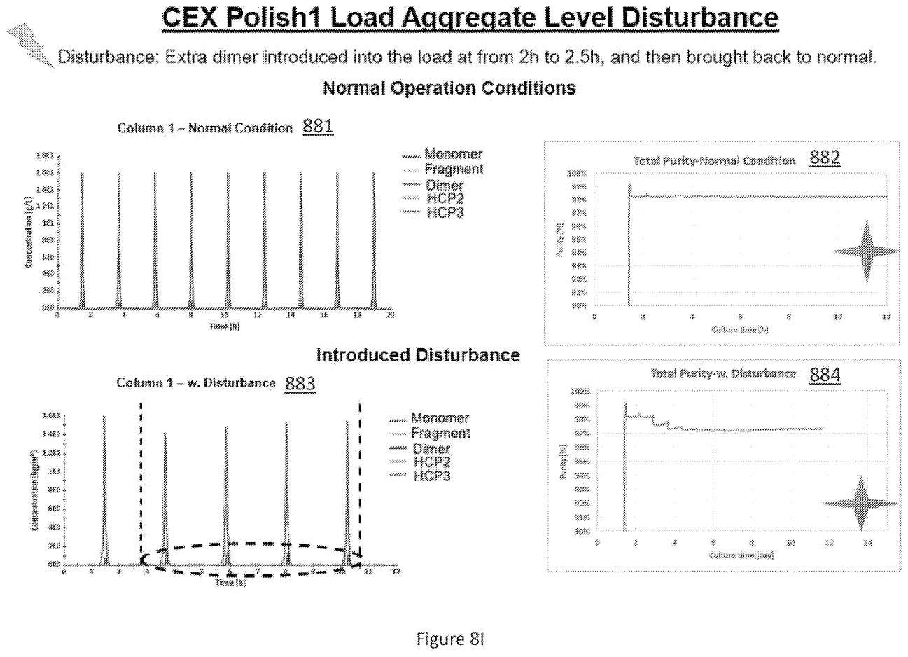

FIG. 5C also shows a Physical-to-Cloud connect architecture end-to-end model development process flow, that is divided into three main components: 1) on-premises physical systems 560, 2) backend cloud infrastructure 550, and 3) computational predictive modeling for drug development and biomanufacturing process control 570. The on-premises physical systems 560 can include physical systems (e.g. bioreactors, electro-mechanical systems, chemical systems, etc.) that are used for processing biological substances. The on-premises physical systems 560 can include the biomanufacturing systems 536 described with reference to FIG. 5B. A model 562 of the on-premises physical systems 560 can be based on physics-driven mathematical processes, for example any of the biological process digital twins described with reference to FIG. 7 through FIG. 10. For example, the model 562 may correspond to the biological process digital twin shown in FIG. 8A-1.

Certain site-level components (e.g. AWS IoT Greengrass, AWS IoT Sitewise running on AWS Outpost) can serve as a bridge between the on-premises physical systems 560 and the backend cloud infrastructure 550. The storage of models and datasets, model development, training and testing, machine learning, deployment etc. will be performed on the backend cloud infrastructure 550. In the example shown in FIG. 5C, AWS Kinesis (or any similar non-AWS cloud artifact) can be used for data streaming from the physical systems into the models through AWS IoT Core or similar non-AWS cloud artifact. In a non-limiting example, AWS S3 Bucket (or any similar non-AWS cloud artifact) can be used for data storage while AWS Redshift or similar non-AWS cloud artifact can be used as a cloud-level historian (data warehouse) that can also feed the data into the machine learning algorithms and the digital twin models. In another non-limiting example, AWS Twin maker and Sagemaker (or any similar non-AWS cloud artifacts) can be respectively used to develop and deploy the digital twins and the machine learning models. The other components in FIG. 5C such as AWS Lambda, Glue, Athena, etc. (or any similar non-AWS cloud artifacts) can serve as connecting middleware components to operationalize the cloud infrastructure.

FIG. 5D shows a detailed overview of the computational predictive modeling 570 from FIG. 5C. The AWS Sagemaker ecosystem (or any similar non-AWS cloud ecosystem) can be used for machine learning (ML) and digital twin development and deployment. At a high level, the machine learning model development phase can be conducted in a multi-step fashion, for example 1) Training the data (e.g. using AWS S3, Jyputer notebook, etc. or any similar non-AWS cloud artifact), 2) Training the model leveraging any existing models available in AWS Sagemaker or any similar non-AWS cloud artifact, and 3) Deploying the model (e.g. using AWS Load balancer, API gateways, etc. or any similar non-AWS cloud artifacts).

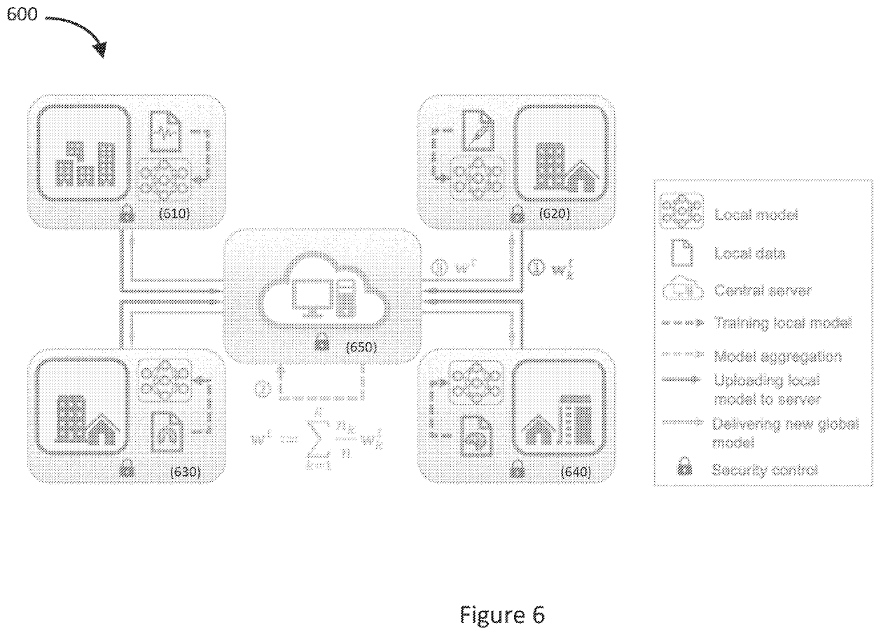

FIG. 6 shows a diagram of an exemplary biosecure digital twin system 600 using a federated learning framework. As shown, the machine learning model therein can be trained in a distributed manner where multiple digital twins 610, 620, 630, 640 periodically transmit local updates to a central server 650. In some embodiments, the central server 650 can aggregate the updates and send back parameters of the updated global learning model to the digital twins 610, 620, 630, 640. In some embodiments, a convolutional neural network (CNN) for cognitive behavioral quality monitoring can be employed to gain insights from cognitive behavioral indicators. Such CNNs may collect and analyze behavioral patterns (e.g., human errors due to fatigue) that can be subsequently classified, logged, and addressed.

### Cyber Physical Digital Twin for Biological Processing

As biological systems are complex with unknown and complex underlying mechanism, a mechanistic model can be used as described herein to model the mechanism/phenomenon, whereby data-driven models based on artificial neural networks (ANN) can be used to compensate for any lack of knowledge. Further, the use of the digital twins described as follows for recipe optimization, monitoring, soft sensing, variability analysis, and anomaly detection can reduce experimentations, accelerate scale-up, optimize process conditions, and improve productivity

Process oriented digital twins can leverage highly automated dataset generation and algorithm tuning process. The core algorithms may be asset-agnostic and can be rapidly deployed to different biopharma production systems. A model can be developed using physics-based and/or data-driven digital twins, or purely based on historical data (model-free). Three main approaches for developing a digital twin for a particular system may include (1) two-class learning using physics-based digital twins, (2) two-class learning using data-driven digital twins, and (3) one-class learning with no digital twins. The two-class learning using physics-based digital twins may be the most complex yet provide the most accurate approach, and can be particularly effective when a high-fidelity physics-based digital twin is available and high accuracies are required. The two-class learning using physics-based digital twins may comprise dataset generation for both normal and abnormal space and supervised machine learning. In some embodiments, in a two-class learning using data-driven digital twins, the data-driven digital twins can be developed with medium to high fidelity for synthetic dataset generation of the abnormal and/or normal space in conjunction with available normal-space data from the field. In the one-class learning with no digital twins, decision boundaries can be computed using normal-space data from a field based on one-class training.

### Model Calibration

Once a bioreactor model is configured, it needs to be calibrated using data to obtain model parameters. A prerequisite for obtaining bioprocess data for parameter estimation is a data management system that can integrate online bioprocess data and at-line data (such as cell number and viability, metabolites, and product titer and quality). Before proceeding to use the model, a quantifiable assessment of model quality can be performed to identify the key sources of model uncertainty. This is performed to make sure that model uncertainty is negligible compared to impact of process variability or change in process variables.

FIG. 7 shows a diagram of an exemplary learning framework 700. Once the bioreactor model is configured, calibration may be required using data-based model parameters. As such, a data processing and analysis module 720 is provided herein that integrates online bioprocess data and at-line data (e.g., cell number, cell viability, metabolites, product titer, and product quality) by obtaining experimental raw data 710 for parameter estimation. Such experimental raw data 710 may be stored in a warehouse and/or data hub (e.g., BioBright™ and Ignition™) and divided into estimation data 721 and cross-validation data 722. In some embodiments, the estimation data 721 comprises parameter estimation 730 and/or uncertainty estimation based on variance in experimental measurements, whereby the cross-validation data 722 comprises cross-validation or blind testing to estimate the predictive capability of a computer model 750. If the cross-validation is confirmed 741, the calibration is complete 742. If the calibration results are not confirmed, the experimental system 770 and the computer model 750 may be reconfigured/recalibrated using an artificial neural network (ANN) and mechanistic correction 760. In some embodiments, a quantifiable assessment of the computer model's 750 quality can be performed to identify the key sources of model uncertainty, and to confirm that such uncertainties are negligible compared to impact of process variability or change in process variables.

The experimental raw data 710 may be obtained from one or more data sources. Examples of such data sources may include one or more sensors, which may include one or more categories of sensors. Exemplary categories or types of sensors may comprise visual/optical sensors (e.g., cameras, scanners), temperature sensors, pressure sensors, motion detectors, infrared sensors, ultrasonic sensors, microphones, chemical sensors, electrochemical sensors, biological sensors, pH sensors, CO2 sensors, DO (dissolved oxygen) sensor, or any other types of sensors. The one or more sensors may be incorporated into a bioreactor and/or bioreactor system. Any sensors that may be useful for monitoring cell growth and/or health may be incorporated. Any sensors useful for monitoring nutrient consumption may be provided. In some instances, data sources may comprise one or more controllers or other components. One or more data sources may comprise one or more processors that receive data from one or more sensors or other components and/or that generate raw data. One or more data sources may comprise a bioreactor and/or bioreactor system. One or more data sources may comprise one or more data warehouses and/or hubs. In some instances, an intermediary data source (e.g., processor, data, hub) may store and/or convey raw experimental data from a primary data source (e.g., sensor). The data sources may be part of an experimental system 770. In some instances, one or more sensors may be part of an experimental system.

The experimental raw data may undergo data processing and analysis 720. Data from one or more data sources may undergo data processing with aid of one or more processors. The one or more processors may be provided on one or more computing devices, such as one or more servers. The one or more processors may be distributed over a cloud computing infrastructure. Data processing and/or analysis may include reformatting of data. In some instances, data may be reformatted for consistency. Data processing and/or analysis may include dividing the data into one or more groups. In some instances, two or more, three or more, or more than four groups of data may be provided. In one example, the data may be divided into two or more groups, such as estimation data 721 for parameter estimation 730 and cross-validation data 722 for cross-validation 740. In one example, the data may be divided equally into two or more groups. In another example, the data may be divided such that one group contains more data than another group.

The estimation data 721 may comprise parameter estimation 730 and/or uncertainty estimation based on variance in experimental measurements. For instance, the estimation data may include some assessment or calculation of how precise and/or accurate measurements may be. For instance, when there is a larger variance that occurs in an unpredictable manner, there may be less certainty about the data. If there is a variance that occurs in a predictable or understandable manner, then there may be more certainty about the data. In some instances, when there is little variance within a predetermined time frame, there may be more certainty about the data. In some instances, the estimation data (e.g., parameter estimation) may be associated with the raw data and/or certain analyzed values based on sensor data. The estimation data may be provided as a numerical value indicative of degree of uncertainty.

The cross-validation data 722 comprises cross-validation 740 or blind testing to estimate the predictive capability of a computer model 750. The cross-validation may rely on the experimental data, which may be compared with predictive values from the computer model. In some instances, when predictive values match or are within a particular threshold of measured experimental data, the likelihood of cross-validation is increased. In some instances, the parameter estimation 730 may affect the cross-validation. For example, greater uncertainty for experimental data values may provide a larger threshold for comparison, when validating the predictive model and/or experimental data. Conversely, a lesser uncertainty associated with the experimental data values may provide a smaller threshold for comparison, when validating the predictive model and/or experimental data.

The cross-validation may validate 741 the predictive model and/or experimental data. This may occur when the predictive values from the computer model 750 fall within a threshold range of the experimental data values. The threshold range may be variable, optionally based on user input. The threshold range may be variable, based on parameter estimation 730. The validation of the computer model and/or predictive model may also rely on one or more additional or alternative factors. Upon validation, the calibration is complete 742.

If the cross-validation process results in not validating the results, the experimental system 770 and/or the computer model 750 may be reconfigured/recalibrated. In some instances, the re-calibration may occur using a neural network and/or mechanistic correction 760. The neural network may comprise an artificial neural network (ANN). Alternatively or in addition, convolutional neural networks (CNN) or recurrent neural networks (RNN) may be employed. Once the recalibration occurs and/or during the recalibration process, further experimental data 710 and/or predictive data from the computer model 750 may undergo cross-validation 740, until validation 741 occurs.

In some embodiments, a quantifiable assessment of the computer model's 750 quality is performed to identify the key sources of model uncertainty, and to confirm that such uncertainties are negligible compared to impact of process variability or change in process variables.

### Digital Twin for Bioreactor(s)

FIG. 8A-1 shows a diagram of an exemplary process modeling framework for a bioreactor digital twin. In some embodiments, one or more biopharma production systems comprise one or more bioreactors. One or more bioreactors may be provided independently of one another or may interact with one another. The one or more bioreactors may comprise one or more components such as one or more sensors, controllers, nutrients, and/or glucose feeds. A bioreactor may comprise a reactor vessel, with one or more feeds that enter the vessel. The feeds may optionally be driven by a pump. One or more pathways may remove effluent. Optionally, one or more sensors may be provided in or on the vessel and may be useful for monitoring the system. Optionally, an agitation system and/or aeration system may be provided. In some instances, temperature control mechanisms, such as a heater and/or cooling system may be provided.

The process modeling framework shown in FIG. 8A-1 can be used to model the performance of one or more fed-batch bioreactors, and/or one or more batch bioreactors. For a fed-batch bioreactor utilizing a fed-batch process, the bioreactor is fed with substrate materials and supplements, which can extend the duration of culture for higher cell densities or switch metabolism to produce a product (e.g., recombinant proteins and antibiotics). A fed-batch culture is advantageous in that it can extend a culture's productive duration, can be used to switch genes on or off by changing the substrate materials, and can be manipulated for maximum productivity using different strategies. In contrast, for a batch bioreactor, the amount of feed materials (e.g. substrate materials) is fixed, and no extra feeding is used in the bioreactor from beginning to end of a process. Accordingly, a fed-batch process using a fed-batch bioreactor is classified as a semi-continuous process, whereas a batch process using a batch bioreactor is classified as a discontinuous process. Digital twins can be employed for various types of bioreactors and bioreactor systems, including the above types of bioreactors and other types of biomanufacturing systems (e.g. continuous culture systems which include perfusion bioreactors) as described elsewhere herein.

The biosecure digital twin employed herein can provide a robust bioreactor modeling framework that integrates data-driven Artificial Intelligence/Machine Learning models of complex cell dynamics with mechanistic understanding of the bioprocesses to describe and predict the quantitative behavior of bioprocesses. The modeling framework may enable process design and optimization with reduced experimentation, risk, exploration, monitoring, soft sensing, investigation times, and tech transfer friction. The multiscale bioprocess models herein can be embedded in digital applications for advanced decision-support systems that leverage science-based data-calibrated mechanistic models to improve insight and operations.

A bioreactor model may comprise one or more levels of modeling. In some instances, two or more, three or more, or four or more modeling levels may be provided. The various modeling levels may be digitally twinned. The various modeling levels may analyze one or more aspect of a bioreactor and/or bioreactor system. The various modeling levels may optionally interact with a model. In one example, three layers of models may be employed and twinned.

At each of a plurality of modeling levels, a high-fidelity virtual representation of the system can be emulated, to train and normalize machine learning algorithms. Extreme learning and other machine learning algorithms may be employed to refine boundary conditions at each level to reduce false positives. As such algorithms are scaled up, analysis and optimization efficiency will improve anomaly detection for predictive maintenance, safety and security.

In a first level of a modeling system sensors, controller, the nutrient, and the glucose feeds are received and analyzed. In a second level, the bioreactor is modeled as a series of differential equations that defines, for example, the masses and energy balances of nutrients, metabolites, oxygen, carbon dioxide, product titer, viable, dead, and lysed cells, pH, osmolarity, temperature, or any combination thereof therein. Also, the model may determine liquid phase reactions, and gas-liquid exchange hydrodynamics, local phenomenon (e.g., shear stress, micromixing, energy dissipation rates) using computational fluid dynamics (CFD) technology at various scales within a bioreactor. In some embodiments, two or more of the layers are twinned, wherein back propagation, physics, and cell correlation of signature heuristics at each level are run to determine deviations and improve control and optimization strategies to scale up and realize system pareto optimum.

As shown, in some embodiments, the bioreactor modeling workflow comprises a bioreactor system level model 810 which models inputs and outputs from sensors, controllers, nutrients, glucose feeds, etc., or any combination thereof. A bioreactor 3D computational fluid dynamics (CFD) model 820 captures and analyzes hydrodynamics & local phenomenon (e.g., shear stress, micromixing, and energy dissipation rates) that exist at different scales within a bioreactor. Additionally, a bioreactor cell model 830 provides analysis of the cell dynamics in a bioreactor, evolution of the cells as they grow and die, as well as rates of nutrient consumption, metabolite, and product secretion. A reduced order model (ROM) 825 can be used for compartmentalization and in silico design of experiments (DOE) based on spatial distribution of oxygen transfer coefficient (kLa) values obtained from the 3D CFD model 820. The ROM 825 is hydrodynamically coupled to a bioreactor hybrid mechanistic model 835 comprising of a bioreactor process model and a cell model. The bioreactor hybrid mechanistic model 835 employs a series of differential equations to determine, for example, one or more of: mass and energy balances of nutrients, metabolites, oxygen, carbon dioxide, product titer, viable, dead, and lysed cells, pH, osmolarity, temperature liquid phase reactions, and gas-liquid exchange.

The bioreactor system level model 810 may comprise representations of one or more physical components of a bioreactor system. The bioreactor system can include one or more fed-batch bioreactors, and/or one or more batch bioreactors. The physical components may include instrumentation and/or inputs and/or outputs to the bioreactor system. Examples of instrumentation may include sensors, controllers, vessels, processors, and/or any other components. For instances, the model may incorporate a pH controller, a dissolved oxygen (DO) controller, internal pressure, a pH sensor, a dissolved oxygen sensor, a BC sensor and/or BC regulator. The model may take into account headspace pressure, air bubble size, medial, impeller type, mixing, or any other factors. Examples of inputs and/or outputs may include one or more nutrient sources, CO2 sources, acid sources, air sources, and/or oxygen sources. Nutrient feeds, glucose feeds, and/or effluent may be incorporated into the model.

The bioreactor CFD model 820 can be initially generated from a 3D CAD design, that subsequently undergoes finite element discretization for modeling spatial distribution of oxygen transfer coefficient (kLa) values in the bioreactor. The kLa value spatial distribution is used to model transfer of oxygen from gas bubbles into the bioreactor medium (which determines the amount of oxygen available for the bioreactor culture process). The kLa value spatial distribution is provided to a reduced order model (ROM) 825 which enables compartmentalization and in silico design of experiments (DOE). Compartmentalization can include identifying and mapping zones of similar property characteristics, and creating a network of well-mixed zones within the bioreactor. Using the network zones, the ROM 825 can run in silico DOE to optimize for parameters such as working volume, agitation rate, and Kolmogorov length.

The bioreactor CFD model 820 may capture and analyze hydrodynamics and/or local fluidic phenomenon (e.g., shear stress, micromixing, and energy dissipation rates) that may exist within a bioreactor. The model 820 may be useful for separating out intrinsic phenomenon (for example, cell culture kinetics), and process operating procedure. These separated features may be coupled with spatial hydrodynamics of a bioreactor using CFD. In some instances, a bioreactor CFD model may employ one or more CFD techniques, such as computational CFD, reduced order CFD, and/or physics informed NN CFD. Further description of CFD modeling may be provided elsewhere herein.

The ROM 825 can be hydrodynamically coupled to a bioreactor hybrid mechanistic model 835 comprising of a bioreactor process model and a cell model. The cell model may focus on cell dynamics within a bioreactor. For example, cell growth, death, and lysis may be analyzed and/or predicted. Furthermore, nutrient consumption and/or metabolite/product secretion may be incorporated into the cell model. Extracellular reactions may also be analyzed as part of a bioreactor cell model. A kinetics model and/or an ANN model may be useful for determining one or more reaction rates. The bioreactor process model can employ a series of differential equations to determine bioreactor process conditions, for example, one or more of: mass and energy balances of nutrients, metabolites, oxygen, carbon dioxide, product titer, viable, dead, and lysed cells, pH, osmolarity, temperature liquid phase reactions, and gas-liquid exchange. The bioreactor hybrid mechanistic model 835 can be used with the bioreactor system level model 810 to generate a simulation output. Referring to FIG. 8A-2, the simulation output can comprise various plots, for example a first plot showing a fed-batch bioreactor simulated run for different cell concentrations (e.g. total, viable, dead, and lysed) as a function of time, and a second plot showing global sensitivity analysis/optimization (e.g. as a function of dosing schedule and dose volume, liquid composition, and percentage cell viability).

The bioreactor hybrid mechanistic model 835 may interact with one or more model levels (e.g., bioreactor system model 810, bioreactor CFD model 820, and/or ROM 825). In some instances, there may be one-way or two-way data flow between the bioreactor hybrid mechanistic model and various model levels. For example, two-way hydrodynamic coupling may be provided with the bioreactor CFD model. In another example, reaction rates from a bioreactor cell model may be provided to the bioreactor hybrid mechanistic model. In some embodiments, mass and energy balances, such as nutrients, metabolites, oxygen, CO2, product titer and/or viability, pH, gas-liquid exchange, liquid reactions, etc. may be analyzed as part of the bioreactor hybrid mechanistic model.

The cell model in the bioreactor hybrid mechanistic model 835 may describe the evolution of the cells as they grow or die. The bioreactor process model in the bioreactor hybrid mechanistic model 835 also describes the rate of nutrient consumption, metabolite, and product secretion. A kinetic model may be selected representing growth, stationary, and cell death phase. Biological systems are complex and underlying mechanism are not often known or can be described with a fully mechanistic model. A mechanistic model may be used to describe the known phenomenon and data-driven model can fill in the lack of knowledge. Artificial neural networks (ANN) may be used to correct the mechanistic kinetic model parameters. Bioreactor digital twin developed using the above modeling framework may be transformational in bringing significant value across process lifecycle. In process development, the digital twin may help in reducing experimentations, accelerate scale-up, optimize process conditions, and improve productivity. In manufacturing, digital-twins may be used for recipe optimization, monitoring and soft sensing, gauge effects of variability and anomaly detection. Combining these approaches and capabilities may improve the state of the art.

In some embodiments, the bioreactor system level model 810 focuses on granular process system digital twin modeling, whereas the bioreactor hybrid mechanistic model 835 focuses on the modeling of the biological components that are within these electro-mechanical control systems. Combining both models 810 and 835 improves modeling of stochastic closed looped systems (e.g., bioreactors) by leveraging formal methods of proven process oriented physical models to gain insight and improve computational biological models. When backed by high computational capability, such methods and models may significantly improve computation modeling capability to enable secure and efficient manufacturing. Computational modeling associated with the manufacturing process using process-oriented digital twins may enable high fidelity dynamic modeling to advance and optimize the drug development process and quality analysis process and resiliency. The biosecure digital twin may host the digital twins of the individual electro-mechanical manufacturing systems as well as a network of connected systems for end-to-end manufacturing modeling and analysis.

The enabling systems of the drug development process are the large scale and interconnected electro-mechanical control systems that can often be seen in networked environments. Fundamentally, the sensor signals that transform into readable parameters (e.g., pH, DO, cell mass, etc.) are often current-based and voltage-based signals. Accurate modeling of the integral and peripheral electro-mechanical system components and sensors can provide resilience and operational insights to evaluate the efficacy, and perform validation of, the manufacturing processes. This type of modeling may focus on granular process system digital twin modeling. This may be in contrast with biological monitoring, which may focus more on the modeling of the biological components that are within the electro-mechanical control systems.

Combining both approaches may improve modeling of stochastic closed looped systems, such as bioreactors. Formal methods of proven process oriented physical models may be leveraged to gain insight and improve computational biological models. When backed by the computational capability of one or more cloud computing services (e.g., AWS™), this proposed effort would significantly improve the computation modeling capability. Computational modeling associated with the manufacturing process using process-oriented digital twins may enable high fidelity dynamic modeling to advance and optimize the drug development process and quality analysis process and resiliency. The systems and methods for digital twins provided herein, may host the digital twins of the individual electro-mechanical manufacturing systems and the digital twin of an entire network of these connected systems (for end-to-end manufacturing modeling and analysis).

Continuously collecting and processing data from a plurality of instrumentations within a biological process enables an unprecedented level of process characterization, which advances batch comparison, inter-operator variabilities, and identification of anomalies and differences in batch conditions (e.g., PV, rotations per minute (RPM), feed timing, feed nature, feed concentration, and respiratory parameters). As such, real-time data-driven feeds for all collected data from the process in near real-time makes the process analyzable and machine learnable in a way that was not previously possible. For example, when any of the models 810, 820, 825 and 835 are applied to model fed-batch bioreactor systems, one or more of those models can be used to identify, predict and/or detect one or more of the following in real-time: (1) build-up of inhibitory agents or toxins, (2) possible points of ingress for contamination, and (3) bottlenecks in the fed-batch process caused by high cell density numbers and product yields, which may result in process management issues downstream.

Additional advantages include being able to optimize plant simulation, and analysis. By collecting biological scale-up process data, a new level of data-driven digital biosecurity monitoring may be enabled. With this process data available in a reproducible way (API, structured data), and at scale (e.g., tens, hundreds, or thousands of instruments), improved computational models to identify, characterize and improve scale up, integrity, safety and security may be created. The internal algorithms within the computational model can alert an asset operator if it operates outside of the pareto optimum to improve orchestration, visualization and control of large molecule drug development and manufacturing processes model data.

### Digital Twin for Continuous Process Biomanufacturing Platform

A digital twin framework may comprise three levels of models, digital model, digital shadow, and digital twin. The digital model may be the foundational layer of the digital twin framework. The digital model may focus on the localized phenomena in each unit operation, for example, the distribution of hydrodynamic properties inside of a bioreactor. The digital model may serve an array of areas, including unit operation scale-up studies, process optimization to enhance mixing and oxygen transfer coefficient (kLa) values in a bioreactor, and conducting design equivalency assessments. The digital shadow may focus on the system-level models of unit operations. It may envision the impact of varied system level factors including feeding strategy, temperature control, elution strategy, pH control and other process parameters to the unit operation's output. The integration between the digital model and the digital shadow may provide a more precise representation of the physical unit operations by accounting for local effects. Furthermore, by interlinking digital shadows of multiple unit operations, a comprehensive end-to-end digital shadow may represent the entire process. The application of the digital shadow may cover an extensive area, including process optimization, process characterization, root cause analysis, and predictive process control with manual adjustments. The digital shadow may improve process stability through process control. The digital twin may comprise a cohesive system that interconnects the digital shadow with the physical plant through the strategic implementation of Process Analytical Technology (PAT). In this system, real-time detection of process parameters may be captured by PAT and seamlessly transmitted to the digital shadow. Subsequently, automated adjustments may be transmitted back to the physical process according to the in-silico prediction. Through this dynamic interaction, the digital twin may achieve the real-time automated process control.

In some embodiments, a continuous bioprocessing process may comprise a perfusion bioreactor, periodic-counter-current chromatography (PCCC), and alternating filters to achieve uninterrupted manufacturing processes. For example, the continuous bioprocessing process may comprise an advanced integrated end-to-end continuous drug substance (e.g., monoclonal antibodies and other biological molecules) manufacturing platform.

In the context of a continuous process, the implementation of an end-to-end digital twin framework may be transformative. Such framework may bring in significant value across process lifecycle and offer a pathway to achieve optimal operating conditions with reduced amount of experimentation to expand process knowledge. Moreover, the real-time detection of deviations in critical process parameters may trigger the use of residence time distribution analysis with the digital shadow platform. This dynamic approach allows for the identification of the duration of product diversion in response to the deviation, enabling the redirection of impacted products without affecting the remainder of the batch

FIG. 8B-1 illustrates a schematic diagram of a continuous biomanufacturing platform 850. The platform 850 is an end-to-end system that can be used for continuous processing (e.g., continuous culture) of drug substances or products (e.g., such as monoclonal antibodies and other biological molecules). As described later with reference to FIGS. 8C through 8I, a digital twin system 860 of the platform 850 can be constructed and used to simulate control strategies for product diversion management during continuous processing. The digital twin system 860 can be used to model the continuous process through the end-to-end system, in contrast to the embodiment of FIGS. 8A-1 and 8A-2 which are used to model processes in batch-fed bioreactors (semi-continuous process) or batch bioreactors (discontinuous process). The platform 850 and its digital twin system 860 can be implemented as a “Biomanufacturing-as-a-Service” (BaaS), that broadens access to complex medicinal development and protects biopharmaceutical supply chains against disruption.

The platform 850 integrates perfusion bioreactor technology, continuous product capture, continuous low pH viral inactivation, continuous polishing steps, viral filtration, and formulation steps in an end-to-end configuration from upstream to downstream. Referring to FIG. 8B-1, the platform 850 includes a perfusion bioreactor 851, a continuous product capture unit 852, a continuous low pH viral inactivation unit 853, a depth filtration unit 854, continuous polishing units including a cation exchange (CEX) bind/elute 855 unit and an anion exchange (AEX) flow unit 856, a nanofiltration unit 857, a single pass tangential flow filtration (SPTFF) unit 858, and a ultrafiltration diafiltration (UFDF) unit 859. Product exits 848 can be provided at one or more points (e.g., outlets) in the platform 850, for example at 848 from the perfusion bioreactor 851 and/or at 848 (prior to anion exchange flow, or entering the AEX unit 856) as shown. In some instances, disturbances 849 can occur at one or more points in the platform 850, for example at 849 in the perfusion bioreactor 851 and/or at 849 in the CEX unit 855. The disturbances 849 and product exits 848 can be simulated/modeled using the digital twin system 860 as described elsewhere herein, for example with reference to FIGS. 8H and 8I.

In the example of FIG. 8B-1, the bioreactor 851 is perfused continuously, and the product (e.g., a protein or any eluate) is continuously collected using a surge vessel before being fed to the continuous capture operation, where the product is captured using the continuous product capture unit 852. The downstream continuous process in platform 850 is similar to some of the operations in a typical fed-batch platform. For example, the product is subsequently fed from unit 852 to unit 853 for low pH viral inactivation (neutralization). To achieve a hold time target at the low pH, the product stream is fed through a packed bed column to achieve the desired residence time, before being passed through the depth filtration unit 854. After neutralization (853) and depth filtration (854), the product is continuously loaded onto the polishing unit operations, which include the cation exchange (CEX) bind/elute unit 855 (which, for example can be operated in multi-column chromatography mode), followed by an anion exchange (AEX) flow through operation using the AEX unit 856. Next, the product stream is pumped through nanofiltration unit 857 (which, for example can have virus reduction capability), before being passed into a single pass tangential flow filtration (SPTFF) unit 858 having concentration and buffer exchange capability. Once the product accumulates for a specified time period and/or a target mass/volume has been achieved in a pool vessel, an ultrafiltration diafiltration (UFDF) unit 859 can be used in the pool vessel as a retentate tank to deliver a sub-batch at the desired concentration and formulation.

FIG. 8B-2 illustrates an example of the continuous biomanufacturing platform 850 which uses spectroscopy systems and methods (e.g., Raman spectroscopy, near-infrared (NIR) spectroscopy, mid-infrared spectroscopy, etc.) for process monitoring and control. Referring to FIG. 8B-2, one or more spectroscopy instruments 870 may be provided at one or more points (or process units/stations) within platform 850. The spectroscopy instrument 870 at each point (or process unit/station) may include one or more probes that are configured to collect real-time measurements of spectral data at (or in proximity) to the corresponding point (or process unit/station). The spectral data may be provided in real-time to the digital twin system 860 herein, for digital twin modeling and monitoring of bioprocesses. The target to be analyzed may be a starting material (e.g., glucose), an intermediate (e.g., lactate), a product precursor component (e.g., sugar or amino acid), a product, etc., at any one of the points (or process unit/station) within platform 850. A product may be a semi-finished or finished product (a byproduct of bioprocessing/biomanufacturing). A product may include, for example, monoclonal antibodies or other biological molecules.

Raman spectroscopy, for example, relies on inelastic scattering observed when a photon is impinged upon a chemical bond. A Raman spectroscopy instrument can be configured to fire photons of a specific wavelength (energy level) at a target to be analyzed. When the photons enter the electron cloud of the chemical bond, the photons are initially converted into energy and then back into photons and ejected from the bond. With inelastic scattering, the photon loses energy in the form of a wavelength shift. The Raman spectroscopy instrument can be configured to measure the wavelength shift, and a frequency of occurrence for all shifts can be added to generate peaks (resulting in a Raman spectrum or spectral data). The peaks, which represent a count of Raman shifts at a given energy, can be correlated to specific constituents in the target. In some embodiments, the intensities of one or more peaks can be used to determine the concentration of a component or constituent in the target (e.g., by comparing to a standard curve of intensities generated using known concentrations of the component or constituent).

In some implementations, the spectroscopy instrument 870 (e.g., a Raman spectroscopy instrument) can be configured to perform spectroscopy in the visible, near infrared, infrared, near ultraviolet, or ultraviolet (UV) range. In some embodiments, the spectroscopy instrument 870 can utilize a signal enhancement technique known as Surface Enhanced Raman Spectroscopy (SERS), which relies on a phenomenon known as surface plasmonic resonance. In some other embodiments, the spectroscopy instrument 870 can be configured for resonance spectroscopy, tip-enhanced spectroscopy, polarized spectroscopy, stimulated spectroscopy, transmission spectroscopy, spatially offset spectroscopy, difference spectroscopy, Fourier Transform (FT), or hyper spectroscopy. In some embodiments, the spectroscopy instrument 870 can include an analyzer (e.g., a Raman analyzer) configured with a laser or another suitable light source that operates at appropriate wavelengths (e.g., 325 nm, 514.5 nm, 532 nm, 632.8 nm, 647 nm, 752 nm, 785 nm, 830 nm, 1064 nm, etc.).

In some embodiments, spectral data collected by the spectroscopy instrument 870 can be augmented with any other type of spectral data obtained using any technique to collect spectral data. The techniques may include Raman Spectroscopy, Nuclear Magnetic Resonance (NMR), X-Ray Fluorescence (XRF), Small Angle X-Ray Scattering (SAXS), Powder Diffraction, Near Infrared Spectroscopy (NIR), Mid Infrared Spectroscopy, Fourier Transform Infrared Spectroscopy (FTIR), etc.). For example, the augmentation of Raman spectral data may include fusing the Raman spectral data with one or more other types of (non-Raman) spectral data to generate a combined/fused spectral dataset. The combined/fused spectral dataset can be provided to the digital twin system 860 herein, to enhance digital twin modeling and monitoring of bioprocesses.

The spectroscopy instrument 870 at each point within platform 850 can be configured inline, online and/or atline with the corresponding process unit/station. The various modes (inline, online, and atline) will be described in further detail with reference to FIG. 8B-3. In some embodiments, the spectroscopy instrument 870 may include one or more probes configured inline with a bioreactor, vessel and/or fluidic pathway to non-invasively (e.g., in a sterile fashion) collect spectral data of a sample or product from the bioreactor, vessel and/or fluidic pathway.

As previously described, the platform 850 integrates perfusion bioreactor technology, continuous product capture, continuous low pH viral inactivation, continuous polishing steps, viral filtration, and formulation steps in an end-to-end configuration from upstream to downstream. Referring to FIG. 8B-2, a plurality of spectroscopy instruments 870 (e.g., Raman spectroscopy instruments, near-infrared (NIR) spectroscopy instruments, mid-infrared spectroscopy instruments, etc.) can be provided at different points (or process units/stations) within the platform 850. The spectral data collected by the spectroscopy instruments 870 can be used to improve or optimize one or more processes that are upstream (via one or more feedback loops 871), or one or more processes that are downstream (via one or more feedforward loops 872).

For example, a spectroscopy instrument 870 can be provided at the perfusion bioreactor 851, and another spectroscopy instruments 870 can be provided at a fluidic pathway between the perfusion bioreactor 851 and the continuous product capture unit 852, in a feedback control loop for monitoring and optimizing process conditions at the perfusion bioreactor 851. If the spectral data collected from the above spectroscopy instruments 870 indicates the presence of contaminants or process variations occurring in or from the bioreactor perfusion, appropriate measures can be applied in real-time to adjust the process conditions in the perfusion bioreactor 851.

In some implementations, a spectroscopy instrument 870 can be provided at a fluidic pathway directly prior to the continuous product capture unit 852 in a feedforward control loop configuration. If the spectral data collected from the aforementioned spectroscopy instrument 870 indicates the presence of contaminants or process variations after bioreactor perfusion, appropriate measures can be applied in real-time to prevent the product from entering the continuous product capture unit 852.

In some implementations, a spectroscopy instrument 870 can be provided at a fluidic pathway directly after the continuous product capture unit 852 in a feedback control loop configuration. If the spectral data collected from the aforementioned spectroscopy instrument 870 indicates the presence of contaminants or process variations after continuous capture, appropriate measures can be applied in real-time to identify and mitigate issues that may be occurring at the continuous product capture unit 852.

In some implementations, a spectroscopy instrument 870 can be provided at a fluidic pathway directly prior to the continuous low pH viral inactivation unit 853 in a feedforward control loop configuration. If the spectral data collected from the aforementioned spectroscopy instrument 870 indicates the presence of contaminants or process variations after continuous product capture, appropriate measures can be applied in real-time to prevent the product from entering the continuous low pH viral inactivation unit 853 for neutralization.

In some implementations, a spectroscopy instrument 870 can be provided at a fluidic pathway directly prior to the depth filtration unit 854 in a feedforward control loop configuration. For example, if the spectral data collected from the aforementioned spectroscopy instrument 870 indicates the presence of contaminants or process variations after low pH viral inactivation, appropriate measures, such as switching the process stream to waste, holding tanks, or alternative processing pathways, can be applied in real-time to prevent the product from entering the depth filtration unit 854.

In some implementations, a spectroscopy instrument 870 can be provided at a fluidic pathway directly after the depth filtration unit 854 in a feedback control loop configuration. If the spectral data collected from the aforementioned spectroscopy instrument 870 indicates the presence of contaminants or process variations after depth filtration, appropriate measures can be applied in real-time to identify and mitigate issues that may be occurring at the depth filtration unit 854.

In some implementations, a spectroscopy instrument 870 can be provided at a fluidic pathway directly prior to the cation exchange (CEX) bind/elute unit 855 in a feedforward control loop configuration. If the spectral data collected from the aforementioned spectroscopy instrument 870 indicates the presence of contaminants or process variations after depth filtration, appropriate measures can be applied in real-time to prevent the product from entering the CEX bind/elute unit 855.

In some implementations, a spectroscopy instrument 870 can provided at a fluidic pathway directly after the CEX bind/elute unit 855 in a feedback control loop configuration. If the spectral data collected from the aforementioned spectroscopy instrument 870 indicates the presence of contaminants or process variations after CEX bind/elution, appropriate measures can be applied in real-time to identify and mitigate issues that may be occurring at the CEX bind/elute unit 855 (for example, pertaining to multi-column chromatography).

In some implementations, a spectroscopy instrument 870 can be provided at a fluidic pathway directly prior to the anion exchange (AEX) flow unit 856 in a feedforward control loop configuration. If the spectral data collected from the aforementioned spectroscopy instrument 870 indicates the presence of contaminants or process variations after CEX bind/elution, appropriate measures can be applied in real-time to prevent the product from entering the AEX flow unit 856.

In some implementations, a spectroscopy instrument 870 can be provided at a fluidic pathway directly after the AEX flow unit 856 in a feedback control loop configuration. If the spectral data collected from the aforementioned spectroscopy instrument 870 indicates the presence of contaminants or process variations after AEX flow, appropriate measures can be applied in real-time to identify and mitigate issues that may be occurring at the AEX flow unit 856.

In some implementations, a spectroscopy instrument 870 can be provided at a fluidic pathway directly prior to the nanofiltration unit 857 in a feedforward control loop configuration. If the spectral data collected from the aforementioned spectroscopy instrument 870 indicates the presence of contaminants or process variations after AEX flow, appropriate measures can be applied in real-time to prevent the product from entering the nanofiltration unit 857.

In some implementations, a spectroscopy instrument 870 can be provided at a fluidic pathway directly after the nanofiltration unit 857 in a feedback control loop configuration. If the spectral data collected from the aforementioned spectroscopy instrument 870 indicates the presence of contaminants or process variations after nanofiltration, appropriate measures can be applied in real-time to identify and mitigate issues that may be occurring at the nanofiltration unit 857.

In some implementations, a spectroscopy instrument 870 can be provided at a fluidic pathway directly prior to the single pass tangential flow filtration (SPTFF) unit 858 in a feedforward control loop configuration. If the spectral data collected from the aforementioned spectroscopy instrument 870 indicates the presence of contaminants or process variations after nanofiltration, appropriate measures can be applied in real-time to prevent the product from entering the SPTFF unit 858.

In some implementations, a spectroscopy instrument 870 can be provided at a fluidic pathway directly after the SPTFF unit 858 in a feedback control loop configuration. If the spectral data collected from the aforementioned spectroscopy instrument 870 indicates the presence of contaminants or process variations after single pass tangential flow filtration (SPTFF), appropriate measures can be applied in real-time to identify and mitigate issues that may be occurring at the SPTFF unit 858.

In some implementations, a spectroscopy instrument 870 can be provided at a fluidic pathway directly prior to the ultrafiltration diafiltration (UFDF) unit 859 in a feedforward control loop configuration. If the spectral data collected from the aforementioned spectroscopy instrument 870 indicates the presence of contaminants or process variations after SPTFF, appropriate measures can be applied in real-time to prevent the product from entering the UFDF unit 859.

In some implementations, a spectroscopy instrument 870 can be provided at a fluidic pathway directly after the UFDF unit 859 in a feedback control loop configuration. If the spectral data collected from the aforementioned spectroscopy instrument 870 indicates the presence of contaminants or process variations after ultrafiltration diafiltration (UFDF), appropriate measures can be applied in real-time to identify and mitigate issues that may be occurring at the UFDF unit 859.

The use of multiple spectroscopy instruments 870 at different points within the platform 850, in a combination of feedback control loop configurations and feedforward control loop configurations, can enable improvements in end-to-end bioprocessing/biomanufacturing monitoring and control. The spectral data can be provided to the digital twin system 860 (of the platform 850) to enhance digital twin modeling and simulations. The digital twin system 860 can be constructed and used to simulate control strategies for product diversion management during continuous processing. The digital twin system 860 can be used to model the continuous process end-to-end, for example the process shown in FIGS. 8B-1 and 8B-2. In some embodiments, the spectral data can be stored and retrieved from a database, that is part of or coupled to the digital twin system 860. The spectral data can be stored or indexed in a manner that relates to culture component levels (e.g., glucose levels) or bioreactor conditions, along with a variety of other relevant information pertaining to continuous bioprocessing.

It is noted that any number (and type) of spectroscopy instruments can be provided at any point within the platform 850, and need not be limited to the example shown in FIG. 8B-2. In some embodiments, one or more of the spectroscopy instruments 870 in the example of FIG. 8B-2 can be omitted, or replaced with another type of spectroscopy instrument. In other embodiments, one or more additional spectroscopy instruments can be added to any point within the platform 850.

The spectroscopy instruments 870 in FIG. 8B-2 can be incorporated inline, online or atline at any point within the platform 850. FIG. 8B-3 is a schematic showing the differences between collecting measurements (e.g., of spectral data) online, inline and atline. The differences between each of the above measurement modes (online, inline and atline) may be based on the location of the spectroscopy instruments 870 and the origin or destination of the sample or product. For example, inline can be an in situ measurement mode, whereby parts of a spectroscopy instrument are located at a bioreactor (or bioprocessing unit) or fluidic pathway itself, and the spectroscopy instrument transmits optical signals directly into a product or sample that is being processed or transported. For online measurements, the spectroscopy instrument can be placed completely outside (in proximity to) the bioreactor (or bioprocessing unit) or a main fluidic pathway 874, at a secondary fluidic pathway 875 having an inlet 876 that diverges a portion of the product or sample for spectroscopy measurements. The portion of the product or sample can be subsequently re-diverted at outlet 877 back to the main fluidic pathway 874 for continuous processing. For atline measurements, the spectroscopy instrument can be placed completely outside of the bioreactor (or bioprocessing unit) and fluidic pathway, external to another secondary fluidic pathway 878 having an inlet 879 that diverges a portion of the product or sample for spectroscopy measurements, and an outlet 880 for the portion of the sample or product to exit for spectroscopy measurements. Unlike the online mode, the portion of the sample or product that exits in the atline mode may not re-diverted back for continuous processing. For measurements that are collected atline, the exited portion 873 of the sample or product can be further transported to another location (offline) for further analysis or processing, as shown in FIG. 8B-3.

The following are some exemplary applications in which spectroscopy can be used to enhance process monitoring and control in a biomanufacturing environment, alone or in conjunction with a digital twin system. As an example, Raman spectroscopy can be used non-invasively (e.g., in a sterile manner) to monitor and/or determine levels of culture components or certain elements in a bioreactor or other vessel.

### (I) Use of Spectroscopy for Measuring and Controlling Critical Quality Attributes (CQAs) in Bioprocesses

Traditionally, CQAs can be difficult to monitor during bioprocessing due to delay time (associated with time required for analysis), as well as the types of analysis available. Those challenges can make monitoring CQAs during process development and manufacturing difficult to perform in real-time while a process is running (e.g., during continuous processing). Those challenges can also slow down process development activities and make those activities more expensive. Being able to monitor CQAs during process development rapidly and continuously can help to significantly improve the speed at which process and product development takes place. Being able to monitor CQAs during manufacturing operations can also aid in the prediction of batch success and release.

The spectroscopy instruments 870 and configurations described herein can be used for measuring and controlling critical quality attributes (CQAs) in bioprocesses. The instruments 870 can be configured to measure CQAs rapidly in real-time and continuously throughout bioprocessing. Examples of CQAs for real-time monitoring can include glycosylation, glycation, product concentration, product aggregation, bioburden, HCP content, endotoxin, and/or chemical formulations.

### (II) Automated Atline Spectroscopy for Controlling Process Variables in Cell Cultures

The spectroscopy instruments 870 described herein can be configured to perform automated atline spectroscopy and chemometric modeling techniques for real-time assessments, monitoring and control of cell cultures. The real-time assessments of cell cultures can be further analyzed using signal processing techniques, to enable precise continuous feedback and model predictive control of cell culture process variables. Through the use of real-time data from spectroscopy, the process variables within the cell culture may be continuously or intermittently monitored. The platform 850 can further include one or more automated feedback controllers configured to maintain the process variables at predetermined set points, or maintain a specific feeding protocol that delivers variable amounts of agents to the bioreactor to maximize bioproduct quality.

For example, the level of a component during bioprocessing can be used to monitor the progress of the bioprocess. As an example, if glucose is to be consumed during bioprocessing, the presence of the same level of glucose at the end of the bioprocess and at the beginning of the bioprocess is an indicator that the bioprocess is not proceeding as desired. In addition, the presence of a new component can be an indicator that the bioprocess is proceeding (or not proceeding) as planned. Thus, a biological production process may be monitored for the occurrence of a desired product or indicator that the process is progressing as desired. On the other hand, the presence of a certain metabolite may be a sign that cells in the biological production process are not generating the desired product but, for instance, are merely proliferating. Thus, determining the presence of one or more components (for example, by using spectroscopy instruments) in a biological sample is a way of evaluating the sample and predicting the successfulness (e.g., yield) of a biological production process.

### (III) Spectroscopy for Measuring and Controlling Metal Concentrations in Cell Cultures

Variable metal concentrations in cell culture have been shown to impact cell culture performance. Optimizing and maintaining metal concentrations can improve product quality, product productivity, cell viability, and general cell health. Traditionally, measuring metal concentrations in real-time at relevant concentrations in cell culture has proven to be difficult, and it is uncommon to monitor for metal concentrations during a cell culture bioprocess. Although offline methods of measurement exist, those methods typically involve a significant time delay and reduced accuracy/precision.

The spectroscopy instruments 870 and configurations described herein can be used to quickly (near instantaneously) quantify metal concentrations in cell cultures, with aid of data processing techniques. The metals in the cell cultures may originate from a preformulated media that is used in the bioprocess, and are typically not process constituents that are introduced into the bioprocess at specific rates or concentrations. Metals can also be a contaminant (e.g., from stainless steel bioreactor systems, unit operation skids, etc.). The methods described herein can be implemented to detect metals leachables and/or contaminants. The methods described herein can also be implemented for drug substance and drug product quality analysis. Since the spectroscopy instruments 870 and configurations described herein can allow metal concentrations to be quantified continuously either instantly or intermittently, an automated feedback loop can be established to control and maintain metal concentrations. Various examples of automated feedback loops are shown and described, for example with reference to feedback control loops 871 in FIG. 8B-2.

In some embodiments, individual mechanistic unit operation models may be constructed and subsequently interconnected in a flowsheet model using a modeling software for digital process design and operations applications, to achieve the concept of digital shadow.

FIG. 8C illustrates a simulated model 860 of the continuous manufacturing platform 850 of FIG. 8B-1, per one or more embodiments herein. The model 860 can have a digital shadow framework. The model 860 can be used to simulate various processes throughout the platform 850, from end-to-end in an integrated fashion. The model 860 may be referred to interchangeably herein as the digital twin system of platform 850. The simulated model 860 comprises a plurality of process simulation models associated with the different processes that are used in continuous processing/culture. The model 860 (including its various process simulation models) can be used to support material diversion strategies, allowing any product that is impacted by disturbance(s) to be diverted out of the biomanufacturing process stream, without impacting product quality recovered in the batches. The model 860 can be used to support diversion strategies, for example by enabling real-time detection and/or prediction of critical process parameter deviations that fall outside of acceptable ranges. The model 860 can include one or more residence time distribution models, which can be used to inform a duration of product diversion in response to deviations.

FIGS. 8D through 8G show magnified views of the different process simulation models from FIG. 8C. Each process simulation model (corresponding to each unit operation) can comprise a residence time distribution model that is used to capture each unit operation's behavior/trends under normal operation conditions and when subject to disturbances. Each process simulation model provides a science-based individual digital twin of the corresponding unit operation, which (the process simulation) can be calibrated with experimental data. The calibration procedure for the process simulation models may include calibration procedures as described elsewhere herein, for example with reference to FIG. 7. The physics of each unit operation can be captured or modeled using mechanistic models, for example as described with reference to FIGS. 7, 8A-1 and 8A-2. Referring to FIG. 8C, different mechanistic models corresponding to different unit operations can be built individually and connected in a flowsheet model using a simulation process software. The unit operations can be modeled in 1-D, assuming perfect mixing of the materials/media/constituents. Residence time distribution models from the above-described process simulation can be used to model disturbances and inform mitigation strategies. When a disturbance occurs within a continuous manufacturing process (e.g., continuous process), the digital twin system (or model 860) can be used to estimate the duration and severity of the impact on each of the unit operations within the physical platform. This prediction of process performance can provide users and stakeholders with guidance on strategies to divert the product and minimize risks from any process divergences/deviations, which enables a robust manufacturing control strategy.

Accordingly, the digital twin system (e.g., model 860) comprising a plurality of process simulation models can simulate the interconnected and simultaneous unit operations from end-to-end for the continuous processing platform 850, which enables holistic design and testing of an overall control strategy for the platform. Implementing the overall control strategy can enable resilient continuous biomanufacturing, resulting in an ability to accommodate process disturbance/disruptions while producing consistent product quality.

The process simulation models (in the digital twin system or model 860) are akin to digital elements of the platform 850, and are designed to enable process control and paperless batch documentation in a good manufacturing practice (GMP) environment. In some instances, a control system architecture for the platform 850 can be skid-based control, which may include a supervisory control and data acquisition (SCADA) system and a “paper on glass” Electronic Batch Record (EBR) system. Data warehousing, analysis and modeling capabilities can be further built around the platform 850 and into its simulated model 860, as another aspect of advancing continuous manufacturing process control and operation capabilities.

FIG. 8D is a magnified view of the perfusion bioreactor model 861 of FIG. 8C, including simulation results of the perfusion bioreactor model. The perfusion bioreactor model 861 is used to model a physical perfusion bioreactor, with a plurality of feed lines for nutrients, glucose and liquid source as defined by a global specification having a simulation duration. The global specification can also include a disturbance line for simulating/introducing disturbances to the bioreactor. The output of the bioreactor can be modeled to flow to a plurality of pumps, for example a first pump that directs product to a liquid sink, and a second pump that directs cells to a cell retention device and subsequently to a bioprocessing tank. A return line from the cell retention device back to the bioreactor can be modeled, as well as a viable cell concentration controller and viable cell concentration sensor that can be used to simulate measured cell viability (percentage by volume) and titer numbers. Other controllers and sensors can also be modeled, for example a level controller and a level sensor connected to the liquid source. The perfusion bioreactor model 861 can be used to generate results based on assumed or literature model inputs. The results generated by the perfusion bioreactor model 861 can include concentration values (mg/mL), for example, for fragment, monomer, dimer, HCP1, HCP2, HCP3 and DNA, as shown in the table in FIG. 8D. The perfusion bioreactor model 861 can also be used to generate various plots, for example a plot of cell concentration versus time (for total cells, viable cells, dead cells, and lysed cells) and a plot of titer number versus time.

In some embodiments, the continuous protein production can be achieved through a cell retention device including an alternating tangential flow (ATF) filter. Cells can be recycled back to the bioreactor, while the product is directed downstream. Steady state can be achieved through the introduction of a bleed stream, and the product can be collected within a surge vessel before undergoing the continuous capture operation. The bioreactor, as illustrated in FIGS. 8C and 8D, can be well-mixed with monogenous properties. Mass balance can be solved alongside kinetics for cell growth/cell death, and kinetics for metabolite consumption and secretion.

FIG. 8E is a magnified view of the product capture model, viral inactivation model, and depth filtration model of FIG. 8C, including simulation results of each of the aforementioned models. The product capture model 862 can be used to simulate continuous capture of a protein. The product capture model 862 can model a multi-column liquid chromatography system with a plurality of lines connected thereto. The plurality of lines can be for elution, equilibration, multiple wash steps (e.g., wash1, wash2, wash3), cleaning and flushing. The product capture model 862 can be used to generate a plot of percentage product purity and percentage product recovery as a function of column volumes corresponding to the multi-column liquid chromatography system. Additionally or optionally, the product capture model 862 can be used to generate plots for each column. For example, a first plot showing Column 1 outlet concentrations as a function of column volumes. Additionally, a second plot showing Column 1 species outlet percentages as a function of column volumes, for example for monomer, fragment, dimer, HCP2 and HCP3. The product capture model 862 can also generate a plot of volume flow versus column volumes, for various phases/settings such as load, elution, equilibration, each wash step, strip and flush.

The viral inactivation model 863 can be used to model the collection of eluate from the liquid chromatography system into a tank (e.g. surge vessel) for subsequent feeding to a plug flow reactor for low pH inactivation (neutralization). To achieve a hold time target at low pH, the product stream is fed through a packed bed column (in the plug flow reactor) to achieve the desired residence time. The viral inactivation model 863 can be used to model UV absorbance and conductivity per cycle before, during and/or after the product stream undergoes low pH inactivation (neutralization).

The depth filtration model 864 can be used to model the flow of the neutralized product stream into a concentration tank that is subject to component separation/purification before the products goes to a bioprocessing tank. The depth filtration model 864 can be used to model the splitting of components from the neutralized product (depth filtration), as well as one or more liquid composition sensors at the concentration tank and the bioprocessing tank.

FIG. 8F is a magnified view of the cation exchange (CEX) polish model and anion exchange (AEX) polish model of FIG. 8C, including simulation results of each of the aforementioned models. The CEX polish model 865 and the AEX polish model 866 can model the continuous loading of the product onto the polishing unit operations, after the neutralization and depth filtration steps described above. The CEX polish model 865 can be used to model a cation exchange (CEX) bind/elute unit operation that is operated in multi-column chromatography mode. The CEX polish model 865 can model elution steps (e.g., elution A and elution B), pre-equilibration, equilibration, and wash steps leading to the multi-column chromatography. The CEX polish model 865 can also model the multi-column chromatography process, as well as the bioprocessing tank that receives the output from the chromatography liquid handling system, and sensors such as a liquid composition sensor. The CEX polish model 865 can be used to generate a plot of percentage product purity and percentage product recovery as a function of column volumes corresponding to the multi-column liquid chromatography system in the CEX unit operation. The CEX polish model 865 can also be used to generate a plot of concentration values as a function of column volumes for the CEX unit operation (e.g., for monomer, fragment, dimer, HCP2 and HCP3).

The AEX polish model 866 can be used to model an anion exchange (AEX) flow through operation after the CEX bind/elute. The AEX polish model 866 can model chase, equilibration and strip steps leading to the multi-column chromatography, as well as the multi-column chromatography process. The AEX polish model 866 can be used to generate a plot of percentage product purity and percentage product recovery as a function of column volumes corresponding to the multi-column liquid chromatography system in the AEX unit operation. The AEX polish model 866 can also be used to generate a plot of concentration values as a function of column volumes for the AEX unit operation (e.g., for monomer, fragment, dimer, HCP2 and HCP3).

FIG. 8G is a magnified view of the nanofiltration model and single pass tangential flow filtration (SPTFF) model of FIG. 8C, including simulation results of each of the aforementioned models. The nanofiltration model 867 can be used to model a virus reduction nanofiltration unit. The nanofiltration model 867 can be used to model the flow of the product stream into a concentration tank, that is subject to a component splitter before it goes to a tank that also receives a liquid source. The nanofiltration model 867 can be used to model the splitting of components (for virus reduction), as well as one or more liquid composition sensors at the concentration tank and the tank.

The single pass tangential flow filtration (SPTFF) model 868 can be used to model a single pass tangential flow filtration device with concentration and buffer exchange capability, after the product stream has gone through nanofiltration. The SPTFF model 868 can model a diafiltration buffer and a tangential flow membrane filter that splits the product stream into retentate (that goes to a concentration tank) and permeate. The SPTFF model 868 can also model one or more sensors, for example a pressure sensor for the retentate line, another pressure sensor for the permeate line, and a liquid composition sensor at the concentration tank. The SPTFF model 868 can generate various plots, for example a first plot of pressure over time (in days) for the permeate line, and a second plot of permeate mass flow rate over time (in days).

After the product accumulates for a specified time or to a target mass/volume in the concentration tank, an ultrafiltration diafiltration (UFDF) operation using the concentration tank as a retentate tank can be used to deliver a sub-batch at a desired concentration and formulation. A UFDF model (not shown) can be used to generate results based on assumed or literature model inputs. The results can include various feed concentrations and product concentrations, for example as shown in the table in FIG. 8G.

As described above, filters may comprise dead-end filters (e.g., depth filter and viral filter) and tangential flow filters, including single pass tangential flow filtration (SPTFF) filters and ultrafiltration diafiltration (UFDF) filters. The membrane flux through the membrane may be governed by Darcy's law, where permeate pressure drives mass flow, and membrane selectivity is defined by the retention factor.

Through the connection of these unit operations from perfusion bioreactor to single pass tangential flow filtration (SPTFF) filters, the model's comprehensive execution may provide dynamic insights into the output and performance of each unit operation across all time points (e.g., FIG. 8C). This real-time monitoring and prediction mechanism may be critical in addressing disturbances or deviations encountered within the process. When a disturbance or deviation occurs during the continuous manufacturing process, the digital shadow system may be used to determine the duration and severity of the impact across subsequent unit operations. This prediction insight may provide guidance in effectively redirecting the product out of the process to minimize the risk from process deviations. As a result, this approach may contribute to the establishment of a resilient manufacturing facility, ensuring steady product quality.

Next, simulations of a few common deviation scenarios are provided as examples, including simulation methodologies for the digital twin system.

FIG. 8H illustrates simulation results comparing the effects of temperature disturbance introduced into the perfusion bioreactor model versus normal operation conditions. The perfusion bioreactor model in FIG. 8H can be based on a 50L perfusion bioreactor. Plots 871, 872 and 873 illustrate trends under normal operation conditions as a function of culture time (in days). For example, plot 871 shows a normal temperature trend, plot 872 shows a normal dimer trend, and plot 873 shows a normal titer trend. During normal conditions, the perfusion bioreactor model is assumed to have a productivity of 2.6 g/L/d at t=7 days. The titer and aggregate level are assumed to remain steady for the remainder of the culture duration.

Disturbances can be introduced to the perfusion bioreactor model to observe the impact on the process due to disturbances. Plots 874, 875 and 876 illustrate trends as a function of culture time (in days) when a disturbance is introduced to the perfusion bioreactor model. To simulate a disturbance in the bioreactor model, at t=9 days, a temperature control failure is assumed causing temperature to increase to 38° C., and after 2 days, the temperature control is fixed, allowing the temperature to return to setpoint. A higher temperature causes increased aggregation-therefore the dimer concentration is predicted by the perfusion bioreactor model to rise and peak shortly after the temperature failure, returning to normal levels by around day 15. In parallel, productivity is predicted by the perfusion bioreactor model to decrease to 1.5 g/L/d before recovering.

FIG. 8I illustrates simulation results comparing the effects of load aggregate level disturbance introduced into the cation exchange (CEX) polish model versus normal operation conditions. Plots 881 and 882 illustrate results under normal operation conditions as a function of time (in hours). Plot 881 shows concentration values (e.g., for monomer, fragment, dimer, HCP2 and HCP3). Plot 882 shows total product purity level (%). In the viral inactivation unit operation, when the product is exposed to low pH, antibody aggregation can occur. As a result, more dimer will be introduced to the downstream unit operations. Plots 883 and 884 illustrate the results as a function of time (in hours) when a disturbance is introduced into the CEX polish model. In this instance, the disturbance corresponds to excess dimer introduced to the CEX polish step to mimic the dimer aggregations from the viral inactivation step. To simulate the disturbance, extra dimer is introduced into the product load at a timepoint from 2 hr to 2.5 hrs, and subsequently brought down/back to normal. Referring to plots 883 and 884, a broader dimer peak and lower product purity level is seen after the disturbance was introduced, with the CEX polish model predicting a return to acceptable dimer levels after 10 hours.

As seen from the examples of the model simulation results from FIGS. 8H and 8I, residence time distribution models from those simulations can be used to model disturbances and inform mitigation strategies for the platform 850. When a disturbance occurs in the continuous manufacture process, the digital twin system (model 860) can be used to estimate the duration and severity of the impact on one or more of the unit operations within the platform. The prediction of process performance can provide users and stakeholders with guidance on ways to divert the product and minimize the risk of process deviations/disturbances, to achieve a robust manufacturing control strategy.

Chromatography unit operations may contain Protein A (e.g., product capture model 862), Cation Exchange Chromatography (CEX) (e.g., CEX polish model 865), and Anion Exchange Chromatography (AEX) (e.g., AEX polish model 866). Employing multi-column chromatography modes, these operations may achieve continuous capture and polish steps. The continuous capture system may produce a frequent discrete production elution, which is collected into a surge vessel to form a homogeneously mixed transient protein A elution pool that feeds to low pH inactivation step.

In some embodiments, the periodic-counter-current chromatography (PCCC) may comprise multiple interconnected columns where one column may be loaded with the outlet of another column. Within each column, different processes including loading, binding, elution, and receiving may take place in order. The radial direction concentration gradient may be neglected and the intraparticle mass transfer may be lumped into the apparent axial dispersion coefficient or kinetic adsorption isotherm parameters. Convection and axial dispersion may be considered in the mass transfer equation.

### CFD Modeling

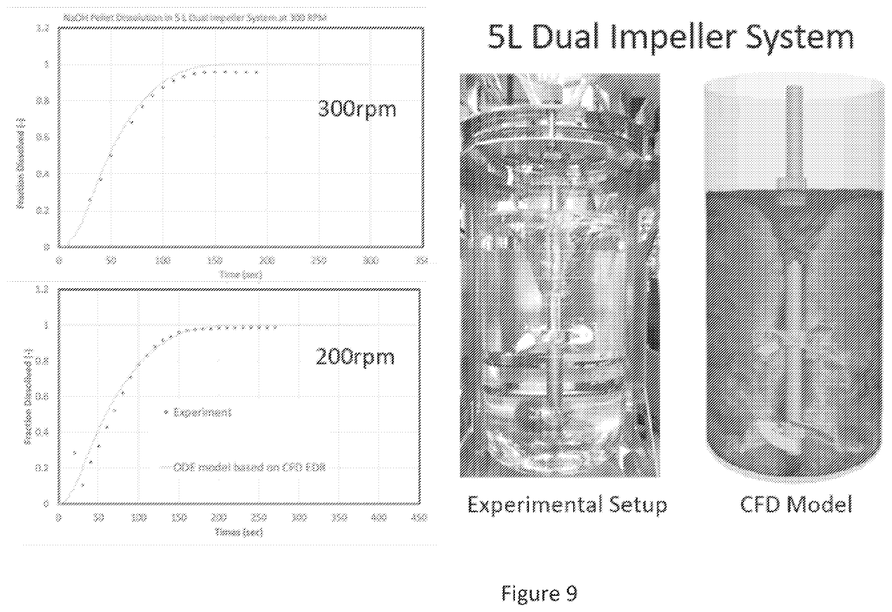

FIG. 9 shows images of an exemplary computational fluid dynamics (CFD) analysis of a dual-impellor system. As previously described, CFD models may aid in improved accuracy and performance. An exemplary experimental set up, which may utilize a five-liter dual impeller system, is illustrated, beside a CFD model.

A CFD model may capture and analyzes hydrodynamics and/or local fluidic phenomenon (e.g., shear stress, micromixing, and energy dissipation rates) of the corresponding experimental set up. The model may be useful for separating out intrinsic phenomenon (for example, cell culture kinetics), and process operating procedure.

In some embodiments, the models and methods herein couple intrinsic phenomenon (e.g., cell culture kinetics and process operating procedures) with spatial hydrodynamics of a bioreactor using CFD tools (e.g., MSTAR, ANSYS, and Siemens PSE's gPROMS). CFD tools may utilize any type of technique as applicable, which may include, but are not limited to discretization methods (e.g., finite volume methods, finite element methods, finite difference methods, spectral element methods, Lattice Boltzmann methods, vortex methods, boundary element methods, high resolution discretization schemes), turbulence models (Reynolds-averaged Navier-Stokes), Boussinesq hypothesis, Reynolds stress model, large eddy simulation, detached eddy simulation, direct numerical simulation, coherent vortex simulation, PDF methods, vorticity confinement methods, linear eddy models, etc.) and/or two-phase flow. Additionally, the methods herein employ model order reduction techniques (e.g., multizonal approaches and reduced order modeling (ROM), and artificial intelligence (AI) techniques to reduce the CFD CPU execution time by several orders of magnitude and enable real-time execution. In some embodiments, the models and methods herein enable the study of the impact of local hydrodynamics phenomenon on bioreactor cell culture for upscaling and operating condition optimization.

The solution from CFD dataset may be coupled to system, mechanistic, and cell models. The final model may be at cellular scale, which may provide the cell dynamics in a bioreactor.

CFD modeling may be actively used across a residual network (i.e., RES network) to enable rapid performance assessment, process optimization, and scale-up of bioreactors and stirred tank mixers. These models may be used for identification, mitigation, and optimization of any sub-optimal mixing conditions and enable the teams to reduce experimentation. One of the applications where CFD models may be utilized can be for optimizing or improving operating conditions for buffer and media prep tanks without the need for experimental testing.

The CFD modeling methods herein identify, mitigate, and optimize bioreactor conditions to enable rapid performance assessment, process optimization, and scale-up of bioreactors and stirred tank mixers. CFD models described herein optimize operating conditions for buffer and media prep tanks without the need for experimental testing. Targeted small-scale experimentation of solid dissolution physics and vortex formation was performed to test and validated the hybrid mechanistic CFD model.

### Bioreactor Control Systems and Methods

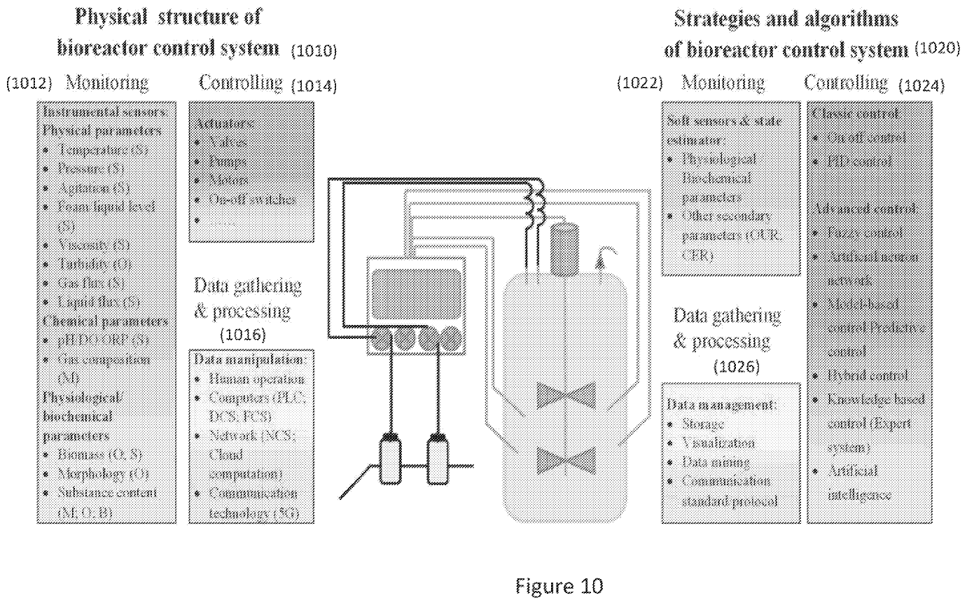

FIG. 10 illustrates an overview of physical structure, instrumentation, actuators and control methods used in bioreactor control systems. A physical structure 1010 of a bioreactor control system may include components relating to monitoring 1012, controlling 1014, and data gathering and processing 1016. Strategies and algorithms 1020 of a bioreactor control system may also include aspects relating to monitoring 1022, controlling 1024, and data gathering and processing 1026. The monitoring components 1012 of the physical structure of a bioreactor control system 1010 may include instrumental sensors for physical parameters (e.g., temperature, pressure, agitation, foam/liquid level, viscosity, turbidity, gas flux, liquid flux, etc.), chemical parameters (e.g., pH, dissolved oxygen, redox potential measurement (ORP), gas composition, etc.), and/or physiological/biochemical parameters (e.g., biomass, morphology, substance content, etc.). Controlling components 1014 may comprise actuators, such as valves, pumps, motors, on-off switches, and so forth. Data gathering and processing systems 1016 may comprise components that may be useful for data manipulation, such as human operation, computers, network, and/or communication technology.

Strategies and algorithms of bioreactor control systems 1020 may include monitoring aspects, such as soft sensors and state estimators. Some examples include physiological/biochemical parameters, or other secondary parameters (e.g., oxygen consumption rate (OUR), or carbon evolution rate (CER)). Controlling aspects 1024 may include classic control (e.g., on/off control, proportional integral derivative (PID) control), advanced control (e.g., fuzzy control, artificial neuron network, model-based control/predictive control, hybrid control, knowledge based control, or artificial intelligence). The system may also include data gathering and processing aspects 1026, which may be useful for data management, such as storage, visualization, data mining, communication standard protocol.

Process oriented digital twins can leverage highly automated dataset generation and algorithm tuning process. The core algorithms may be asset-agnostic and can be rapidly deployed to different biopharma production systems. The model can be developed using physics-based and/or data-driven digital twins or purely based on historical data (model-free). Several approaches for developing a digital twin for a particular system include:
1—Two-class learning using Physics-Based Digital Twins: This is a complex yet accurate approach. This may include of dataset generation for both normal and abnormal space and supervised machine learning. Such a technique may be recommended when the high-fidelity physics-based digital twin is available and very high accuracies are required.
2—Two-class learning using Data-Driven Digital Twins: A data-driven digital twin is developed with medium to high fidelity and is used for synthetic dataset generation of the abnormal space (and potentially the normal space) in conjunction with available normal-space data from the field.
3—One-Class learning with no Digital Twins: No digital twin is used. The decision boundaries are computed using normal-space data only from field based on one-class training.

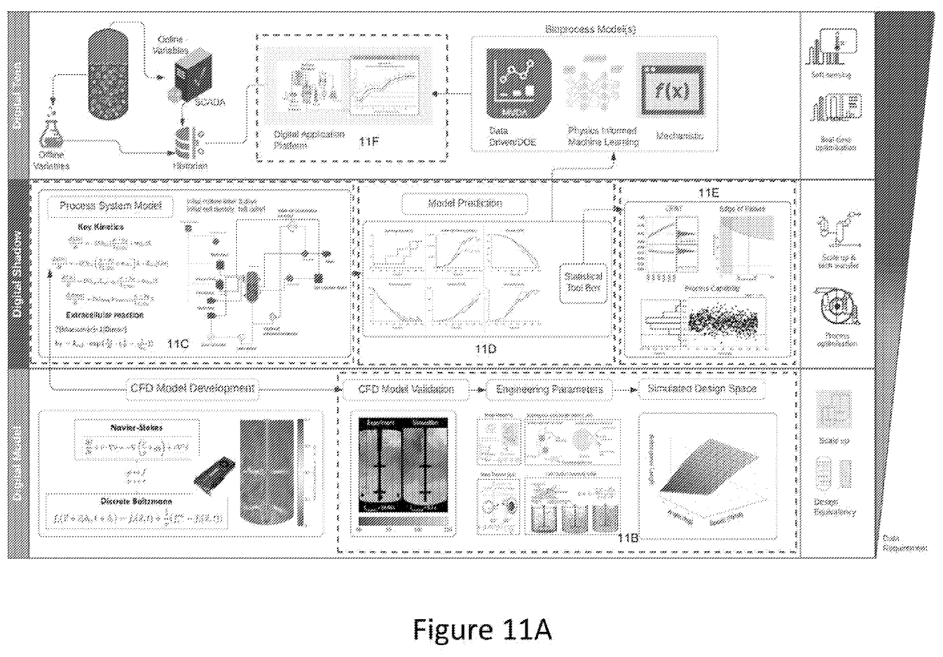

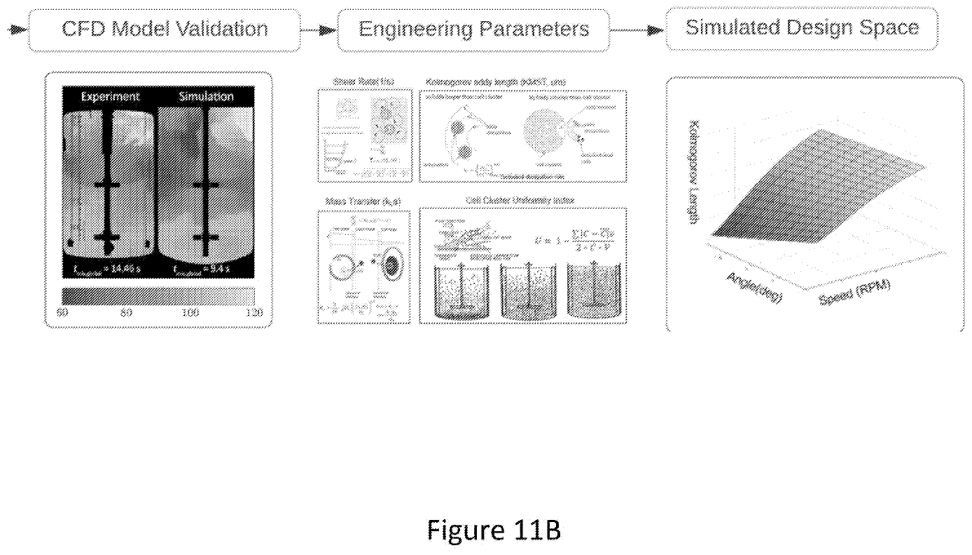

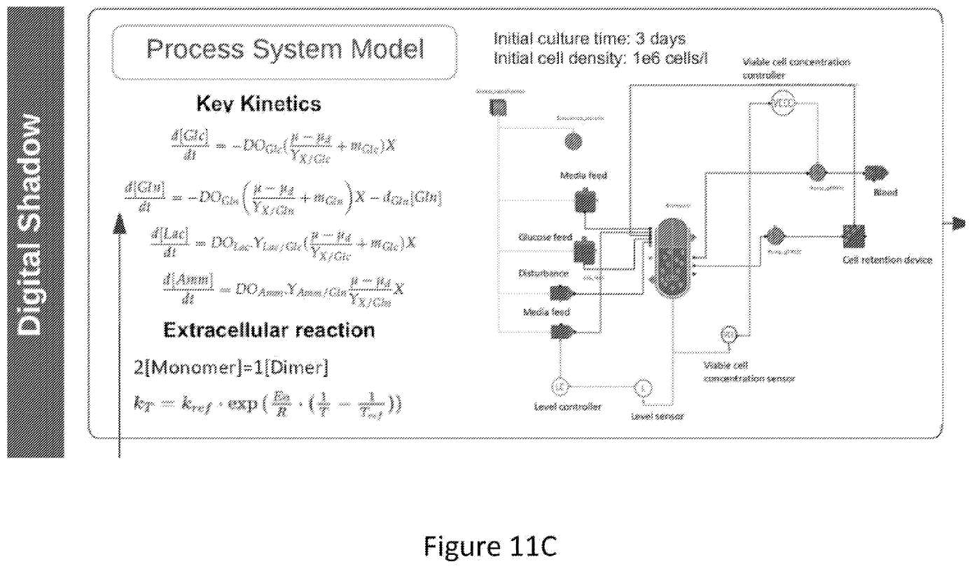

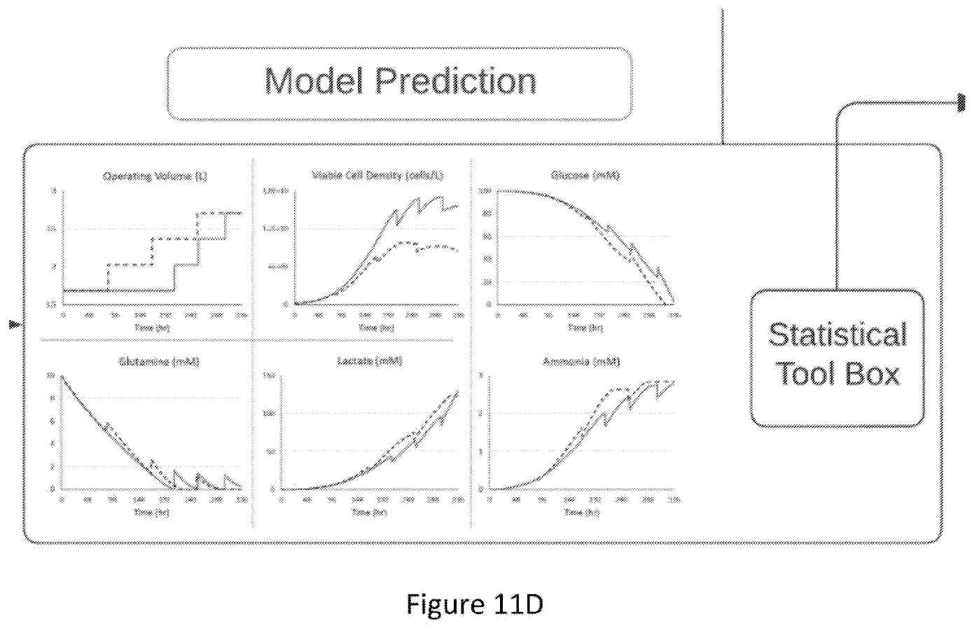

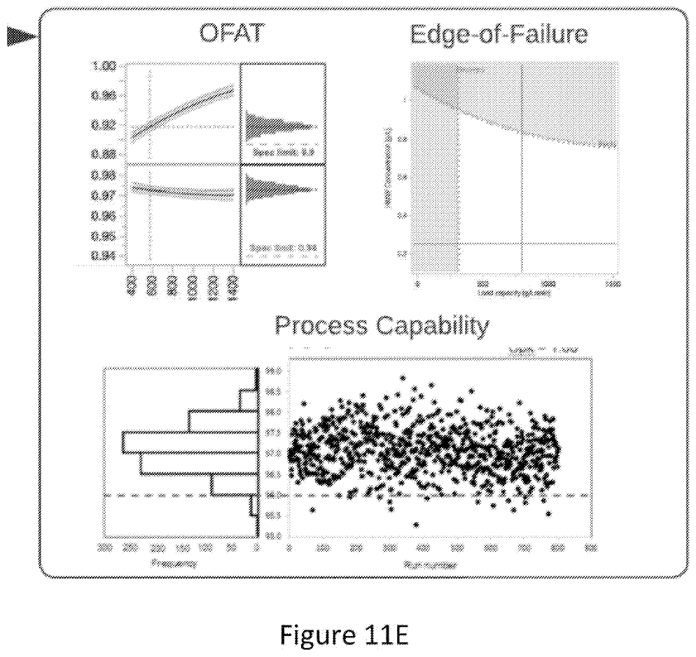

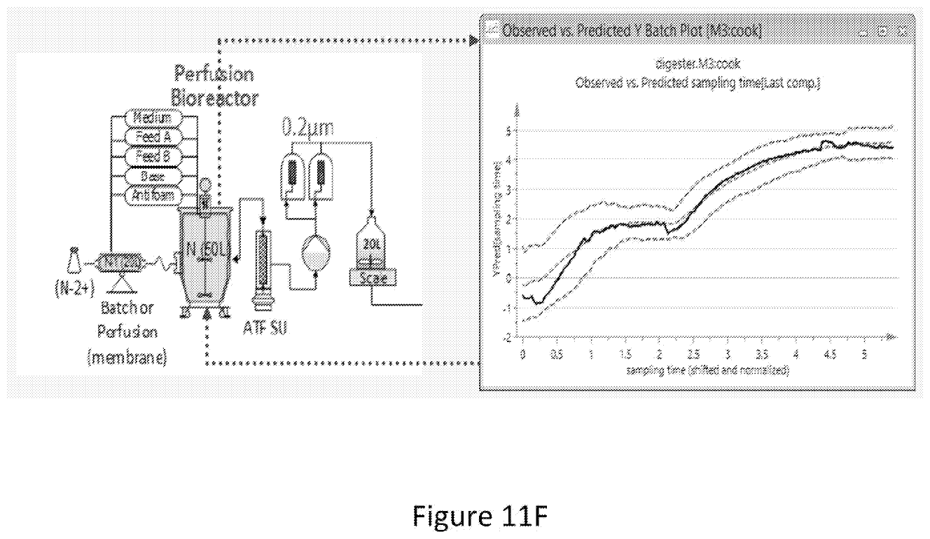

FIG. 11A shows an example of a digital twin framework, per one or more embodiments herein. The digital twin framework may comprise a digital model, a digital shadow, and a digital twin. As illustrated, a computational fluid dynamics (CFD) model is developed. The CFD model may capture and analyzes hydrodynamics and/or local fluidic phenomenon (e.g., shear stress, micromixing, and energy dissipation rates) of the corresponding experimental set up. The model may be useful for separating out intrinsic phenomenon (for example, cell culture kinetics), and process operating procedure. The CFD model may utilize any type of technique as applicable, which may include, but are not limited to Navier-Stokes, and discrete Boltzmann. FIGS. 11B-11F illustrate respective workflows of the digital model, digital shadow, and digital twin, for tracking and adjusting parameters and variables in the biomanufacturing process.

FIG. 11B shows an example of a computational fluid dynamics (CFD) simulation analysis, per one or more embodiments herein. The CFD model is validated by comparing the experiments with simulation results generated by the model. The validation process may enable the fine tuning of engineering parameters, including shear rates, Kolmogorov eddy length (KMST), parameters in mass transfer, and cell cluster uniformity index. The engineering parameters may constitute a simulated design space. As illustrated in FIG. 11B, for example, Two engineering parameters including angle and speed can form a design space for the impact of Kolmogorov length.

FIG. 11C shows an example of a parameter kinetics analysis using a process system model, per one or more embodiments herein. The process system model can be used to determine key kinetics in the bioreactor. For example, the process system model may determine an initial culture time (e.g., 3 days) and/or initial cell density (e.g., 1e6 cells/L), and predict the kinetics of ingredients that are consumed and products that are generated in the bioreactor, as well as other parameters during the operation.

FIG. 11D shows model predictions of parameters, per one or more embodiments herein. As illustrated, the model predicts a plurality of kinetics in the bioreactor, including operating volume, viable cell density, glucose, glutamine, lactate, and ammonia. The green and gray lines represent the performance of the bioreactor with respect to the kinetics under different feeding conditions. As can be seen, viable cell densities increase over time, along with byproducts lactate and ammonia. In contrast, glucose and glutamine decrease over time.

FIG. 11E shows statistical results of one factor at a time (OFAT), edge of failure, and process capability, per one or more embodiments herein. The one factor at a time (OFAT) simulation shows the impact of a single factor or variable, while other variables remain fixed. The simulation also provides a design space where multidimensional combination and interaction of input variables and process parameters can provide assurance of quality. The white area in the design space indicates a safe operating area within the design space, and the shaded area indicates the edge of failure. The process capability simulation provides how consistently a biomanufacturing process can produce products within the specification.

FIG. 11F shows an example of a graphical user interface (GUI) of digital application platform, per one or more embodiments herein. Multiscale bioprocess models herein may be embedded in the digital applications for advanced decision-support systems that leverage science-based data-calibrated mechanistic models to improve insight and operations. As illustrated, the GUI may provide an illustration of the biomanufacturing platform including a perfusion bioreactor. The digital application platform may also generate a comparison between observed data and simulation results. For example, FIG. 11F shows a comparison between observed and predicted sampling time.

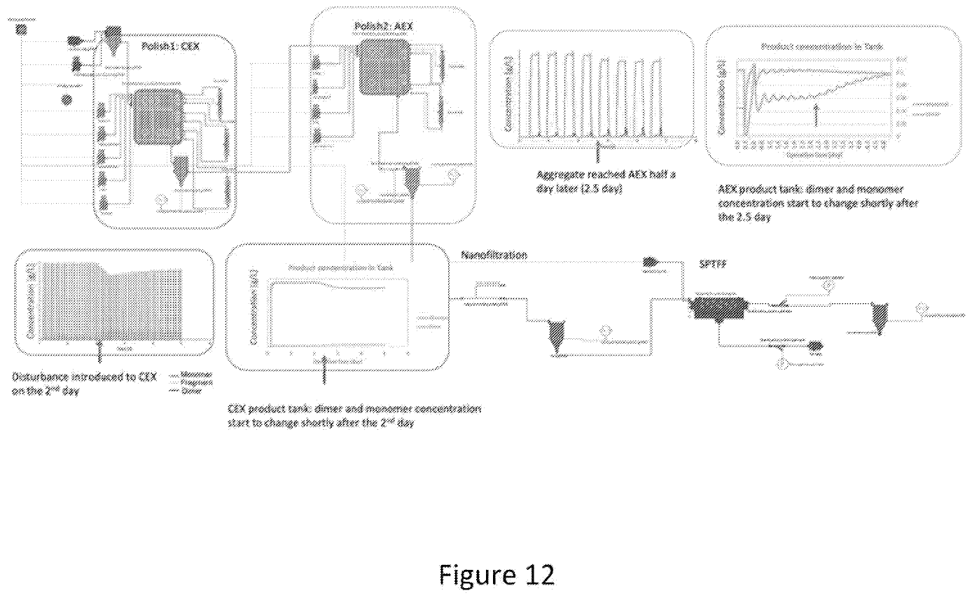

FIG. 12 shows model output for aggregation deviation, per one or more embodiments herein. An artificial introduction of additional dimers into surge vessel before the polish1:CEX operation is carried out. As illustrated in FIG. 12, disturbance (e.g., dimer) is introduced to CEX on the second day. It may be used to evaluate the digital shadow's predictive capabilities in tracking deviations. Following the introduction of deviation, the CEX product concentration in the tank shows dimer and monomer concentration start to change shortly after the second day. The aggregate also reaches polish:2 AEX half a day later (i.e., 2.5 days). The AEX product concentration in the tank shows dimer and monomer concentrations start to change shortly after 2.5 days. As can be see, the fluctuating chromatogram peaks and surge vessel concentrations, following the introduction of the deviation, effectively demonstrate the framework's capability in tracing the progression of the disturbance across unit operations. These predictive capabilities may enable a comprehensive understanding of process capability and performance, thereby ensuring compliance with product quality acceptance criteria. When an out-of-specification event need to be predicted, the digital shadow framework may enable the establishment of control strategies that facilitate the redirection of products out of the process, guided by in-silico predictions. The end-to-end digital shadow framework may seamlessly integrate rea-time insights with predictive ability, improving the reliability, control, and product quality assurance within continuous biomanufacturing process.

### In-Silico Data Driven Mechanical Model Assisted Biopharmaceutical Process Validation

The FDA advocates for the integration of quality by design (QbD) principles throughout the pharmaceutical product development landscape, aiming to elevate both process understanding and product quality. Successful QbD implementation requires a comprehensive understanding of the intricate relationship between critical quality attributes (CQAs), critical performance indicators (CPIs), key performance indicators (KPIs), and the inherent variability in process parameters and raw materials. One challenge for developing a process control strategy during QbD implementation lies in the demanding and resource-intensive nature of the wet lab experimental process characterization studies (PCS). The Design of Experiments (DOE) emerges as a pivotal tool, empowering the development of process knowledge while uncovering the complex multivariate impact of process parameters to product quality and process performance. Following the design of these experiments, the lab work commences; the scale of the experimentation is typically quite significant which reflects the complexity of the process tool. For example, a unit operation with five potential process parameters requires around 50 runs to effectively encompass quadratic effects and multivariate interaction effects. More runs can potentially be required to define the process parameter ranges used to define DOE. These runs entail a substantial time investment, for example, each chromatography unit operation can take around 5-8 hours to finish. In addition, extensive resources are also required to generate feed material for the PCS and qualify analytical methods to test PCS samples. This poses a significant challenge and concern to company resources, considering a complete manufacturing process typically includes six to nine unit operations.

Another hurdle encountered by clinical and commercial manufacturing processes is impact assessments due to process related deviations. Historically, root cause analysis and process/product assessment heavily relied on the process knowledge of Subject Matter Experts (SMEs) that required extensive time to be established. In some cases, the process experience is tacit knowledge that is difficult to transfer to others. This can be detrimental to the manufacturing process as inaccurate conclusions may result in additional deviations reoccurring in subsequent cycles or batches if process history and knowledge are not well maintained.

The digital strategy, as described in various embodiments above, provides a system-level, in-silico model which functions as a predictive powerhouse for evaluating process dynamics and performance. The integration of mathematical models also supports bioprocess development and manufacturing efforts.

Two predominant modeling techniques may provide the in-silico framework: statistical modeling and mechanistic modeling. Statistical models may exhibit exceptional computational efficiency and facilitate automatability thus positioning them as ideal tools for real-time process monitoring and control. The prediction scope of statistical models may be confined to the validated operating space, necessitating a substantial amount of experimental data for model training. In contrast, mechanistic models are rooted in physical and biochemical principles. These mechanistic models may afford profound and scientific process understanding derived from principles governed by natural laws. This imparts longevity to their validity and extends their utility beyond the range of the design space used for model calibration. Consequently, mechanistic models can be robust tools for deviation analysis and process characterization. Furthermore, the number of experiments required for model calibration is substantially lower than statistical models showcasing the additional benefit of efficiency and resource economy.

In some embodiments, a robust and systematic Process Validation (PV) framework may be used for digital shadow assisted process validation. The PV framework may comprise:

1. Process Design with scaled-down models.

a. Design production process and process control to assure that the drug substances/products have the target safety, identity, strength, purity, and quality (SISPQ).

b. Build and maintain process knowledge and understanding.

(2) Process Qualification with at scale runs.

a. Demonstrate the process can consistently produce product with target product qualities.

b. Demonstrate that the commercial manufacturing process can consistently meet the pre-determined process performance with the established process control strategy.

(3) Continued Process Verification during commercial operations.

a. Continual assurance that the process remains in a state of control (the validated state) during routine commercial manufacturing.

One or more the steps above may be implemented by the digital shadow alongside with lab work, thereby significantly reducing the resources needed to improve process understanding and establish process control strategy.

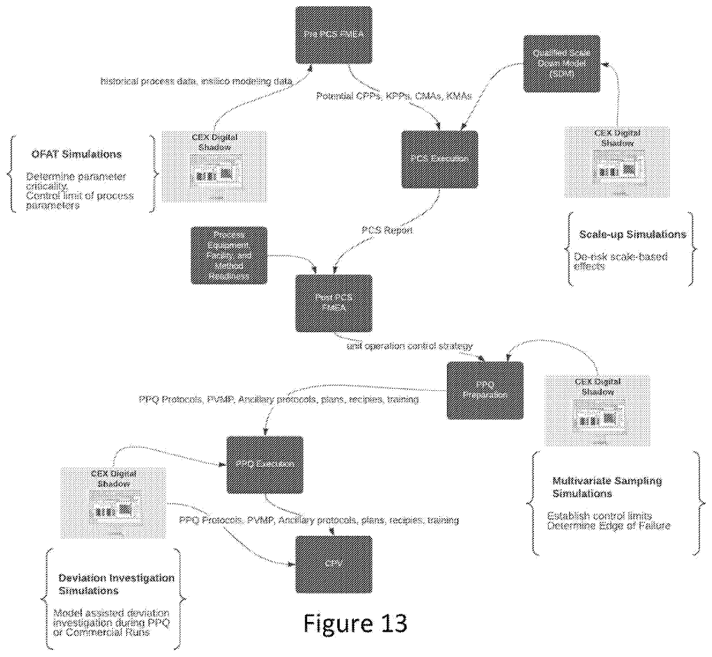

FIG. 13 shows an example of a digital shadow-assisted process validation framework for a Cation exchange chromatography (CEX) unit operation, per one or more embodiments herein. The CEX digital shadow may generate OFAT simulations, comprising determining parameter criticality and generating control limit of process parameters. The in-silico modeling data along with historical process data may be used for Pre process characterization studies (PCS) Failure Mode and Effects Analysis (FMEA). The Pre PCS FMEA may generate potential critical process parameters (CPPs), key process parameters (KPPs), critical material attributes (CMAs), and key material attributes (KMAs) for PCS execution. The CEX digital shadow model may also perform scale-up simulations considering de-risk scale-based effects. The qualified scale down model (SDM) generated from the CEX digital shadow may also be used for PCS execution, which generates a PCS report. The PCS report along with process equipment, facility, and method readiness may be used for post PCS FMEA, which may generate unit operation and control strategy. The CEX digital shadow may also perform multivariate sampling simulations, establish control limits, and determine edge of failure. The simulation results along with the unit operation control strategy generated from post PCS FMEA may be used for process performance qualification (PPQ) preparation. The PPQ protocols, Process Validation Master Plan (PVMP), ancillary protocols, plans, recipes and trainings may be used for PPQ execution. The CEX digital shadow may also perform deviation investigation simulations and assist deviation investigation during PPQ or commercial runs. The simulation results may be also used for PPQ execution and Continuous process verification (CPV).

In some embodiments, the process validation (PV) may comprise process design. A successful validation program may depend on information and knowledge from process development, clinical and/or engineering runs. The process design may comprise one or more of the following steps:
(1) Identification of critical aspects: identify CQAs and CPIs/KPIs and their corresponding specification limits;
(2) Parameter mapping: identify the potential critical process parameters (CPPs), key process parameters (KPPs), critical material attributes (CMAs), and key material attributes (KMAs);
(3) Model scaling: design a scale down model (SDM) and demonstrate that it is representative to the eventual operations at the commercial scale;
(4) Design of experiments: formulate a comprehensive design of experiments (DOE) and execute it with the qualified scale down model (SDM);
(5) Statistical insight: employ statistical analyses to identify the criticalities and relationship of the process parameters; and
(6) Control strategy formulation: Develop the control strategy based on outcomes of the DOE and process knowledge.

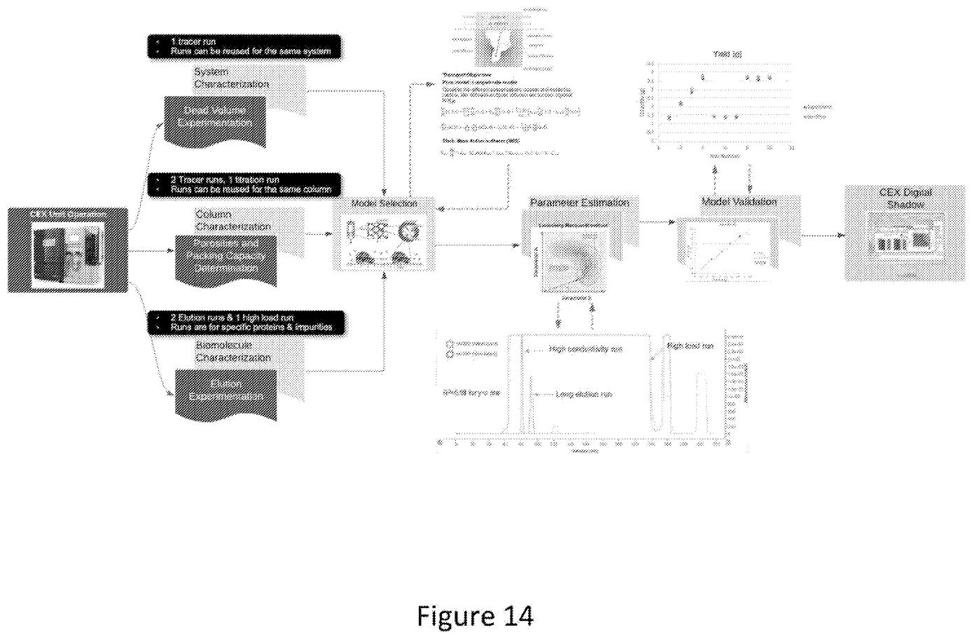

FIG. 14 shows an example of a workflow for digital shadow development shown for a Cation exchange chromatography (CEX) unit operation, per one or more embodiments herein. In the digital shadow-assisted process design, the in-silico model may be defined. In chromatography, three levels of unit operation characterization may be done for model calibration and validation, including system level characterization, where one tracer run may be needed for dead volume calculation; column level characterization, where two tracer runs may be needed for the porosity determination, and one titration run for ionic capacity; and biomolecule level characterization, where two elution runs and one high load run for isotherm parameter calibration may be needed. As illustrated in FIG. 14, initial experiments may be needed as the first step, including dead volume experimentation, porosities and packing capacity determination, and elution experimentation. These experimental results may be used to calibrate the model. In some embodiments, the tracer runs may be performed rapidly without being repeated for different products, assuming that the same system and columns are used. The elution runs, however, are unique to different products and impurities as they provide information on the physiochemical interactions of the protein and resin. The system characterization, column characterization, and biomolecule characterization can be used in model selection, parameter estimation, and model validation. Following the validation of the model, it may transform into the digital shadow for the CEX unit operation.

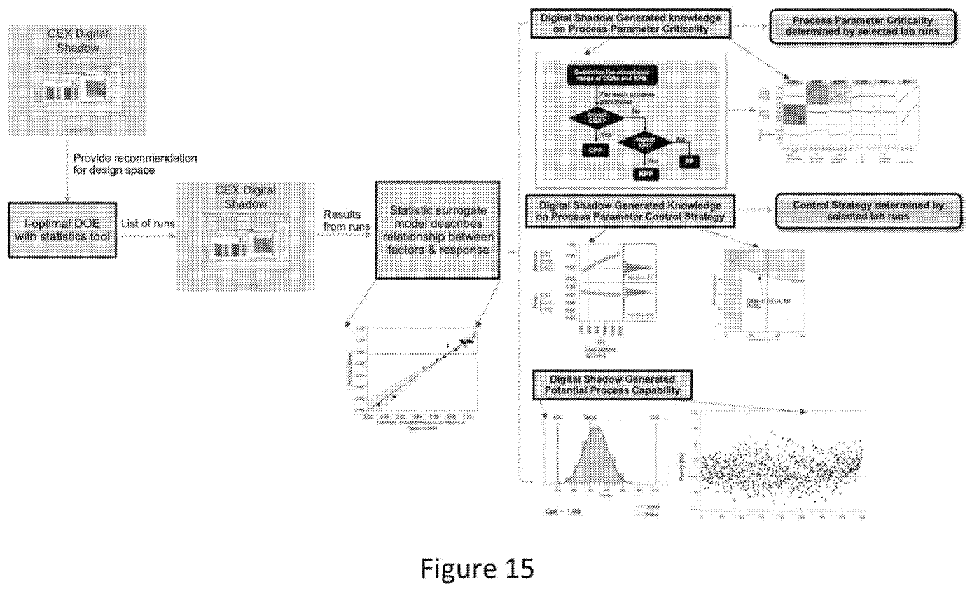

FIG. 15 shows an example of a digital shadow-assisted process characterization platform, per one or more embodiments herein. The CEX digital shadow may provide recommendations for the design space. The optimal DOE (e.g., I-optimal design or D-optimal design) may provide a list of runs to minimize the average variance in prediction. The list of runs is used by the CEX digital shadow model and generated results can be used to build a statistic surrogate model that describes relationships among various factors and responses. For example, the digital shadow may generate knowledge on process parameter criticality, including the determination of acceptance range of critical quality attributes (CQAs) and key performance indicators (KPIs). For each process parameter, the digital shadow may determine whether the CQA is impact. If the CQA is indeed impacted, the digital shadow may determine the parameter's criticality is the critical process parameter (CPP). If the CQA is not impacted, the digital shadow may further determine whether the KPI is impacted. If yes, the model may determine the parameter's criticality is the key process parameter (KPP). If the KPI is not impacted, the model may further determine the parameter's criticality is the process parameter (PP). The digital shadow may also generate knowledge on process parameter control strategy, including one factor at a time (OFAT) and edge of failure as illustrated in FIG. 11E. The digital shadow may also generate knowledge on potential process capacity, as illustrated in FIG. 11F. In some embodiments, the process parameter criticality and/or control strategy may be determined by selected lab runs.

In some embodiments, an expeditious process characterization studies (PCS) with the assistance of digital shadow may be executed. To highlight the impact and velocity of the digital shadow, the previously mentioned unit operation with five process parameters is evaluated across 50 runs estimating 5-8 hours per run. When the digital shadow model is used, these 50 runs may be completed in-silico within 15 minutes. With the knowledge gained from these in-silico runs, the amount of lab work may be significantly reduced. This provides a significant advantage compared to the conventional practice today that exclusively relies on resource-intensive wet lab experiments for the entire DOE design space. Establishing the digital shadow requires only three full length elution runs to calibrate the model and a few additional runs to validate the model; the run time for executing the DOE runs is negligible.

The results from the in-silico runs may be used to build a surrogate model with statistical methods that describe the relationship between the process parameters and hence how the process responds to variations in process input parameters. With this in-silico process, the criticality of the process parameters on performance and quality attributes may be evaluated. This approach provides mechanistic understanding for optimizing lab experiment selection, enabling efficient acquisition of valuable results with a minimal number of lab experiments. The surrogate model may be used to predict the proven acceptable ranges (PARs) of the critical process parameters (CPPs) and key process parameters (KPPs). The predicted PARs may be confirmed with lab experiments. This holistic approach may not only gauge the impact of single parameters, but the surrogate model may also reveal the significance of multivariate interactions. In situations where significant impacts are identified, an edge-of-failure analysis can be carried out. Lab experiments can then be conducted at the identified edge-of-failure parameters to confirm the outcomes from the surrogate model and to make the final refinements to the control strategies. With this approach, the amount of effort, cost and time needed to develop the process validation control strategy can be reduced by 75% compared to a pure lab based approach.

Upon finalization of the control strategy, the digital shadow model may also be used to generate an expected process capability analysis. As an example, employing the Monte-Carlo method, a series of random runs with different combinations of process parameter values within the control strategy may be generated and evaluated with the digital shadow. The outcomes from these runs may then be used to conduct a comprehensive process capability assessment.

### Scale Down Model Qualification

Scale down model (SDM) can be critical for process characterization studies (PCS). Commonly, both lab-scale and at scale runs need to be performed and data from both scale is analyzed statistically to assess any scale-induced disparities. With the digital shadow-assisted SDM qualification, a digital model for commercial-scale unit operation may be defined. As the process scale changes, there may be direct impacts on the fluid dynamic effects caused by differences in equipment geometries. To illustrate in the context of chromatography, columns with identical bed height and smaller inner diameter may be used as SDM. In this scenario, column differences (e.g., wall effects, flow distribution, and radial dispersion effect difference) and system differences (e.g., pressure profile, precolumn dispersion, and system flow path differences) may lead to different column performance, including peak shape, step yield, and impurity clearance. It is important to recognize that while fluid dynamic effects are scale-dependent, the thermodynamic elements such as protein-resin adsorption isotherms may remain invariant. As a result, while implementing mechanistic based digital shadow, the adsorption model parameters derived from lab-scale calibration experiments may be directly transferred to the commercial-scale requiring only the calibration runs to characterize system and column levels. In the case of an observation of discrepancies during chromatography SDM qualification, an offset may be applied to the SDM. The defined digital shadow with both scales may assist in the mechanistic understanding of the scaling impact reflected by the offset parameter.

Process related deviations may occur during process performance qualification (PPQ) runs and routine commercial manufacturing, that could impact product quality and/or process performance. For example, in chromatography, factors including column lifecycle and process variation can lead to atypical chromatograms, resulting in poor product purity or yield. In instances of such deviations, the root cause need to be identified swiftly to facilitate corrections in the subsequent cycles or batches.

In some embodiments, following the process design, a digital shadow for the commercial unit operation may be built and validated. Once validated, the digital shadow may be used to support process and/or product impact assessments which are important elements in process related deviation investigations. The first step of root cause analysis may be to implement a tool like a fishbone analysis to identify the potential parameters that might be the underlying cause the deviation. After the parameters are identified, an inverse modeling method may be employed. In some embodiments, it may involve systematically altering these identified parameters within the digital shadow to align with the observed unit operation performance thus discerning which factor or factors potentially led to the deviation. Furthermore, deviations occurring in a unit operation may stem from variances originating from a preceding unit operation. As a library of digital shadows of distinct unit operations are established for the process, they may be interlinked into an end-to-end process-level digital shadow. This model may be employed to evaluate how the process parameters of one unit operation influence the outcomes of another. The same inverse modeling method may be used to identify root causes in the connected digital shadow.

Development of the digital shadow and evolving it to the digital twin may rely on available data acquisition and sensing capabilities. On-going modeling uses built-in sensor data available, yet an untapped opportunity is to identify sensor and data gaps while relying on built-in sensors. Hence, crafting methods to address those data gaps through peripheral sensors would increase the model fidelity, starting from identifying high-value peripheral sensors needed. Sensor data pipelines may be integrated with Supervisory Control and Data Acquisition (SCADA) and connected to a cloud-computing service. For example, sensor data pipelines may be integrated with Ignition SCADA platform and connected to Amazon Web Services (AWS) through Ignition or Internet of things (IoT) Greengrass platform. Within the AWS environment, models may be built and deployed as infrastructure-as-code (IaC). Such IaC style design, development, and deployment may allow model scalability and enhancements for different unit operations (e.g., chromatography model vs. bioreactor model) and different vendors (e.g., Sartorius system vs. Cytiva system).

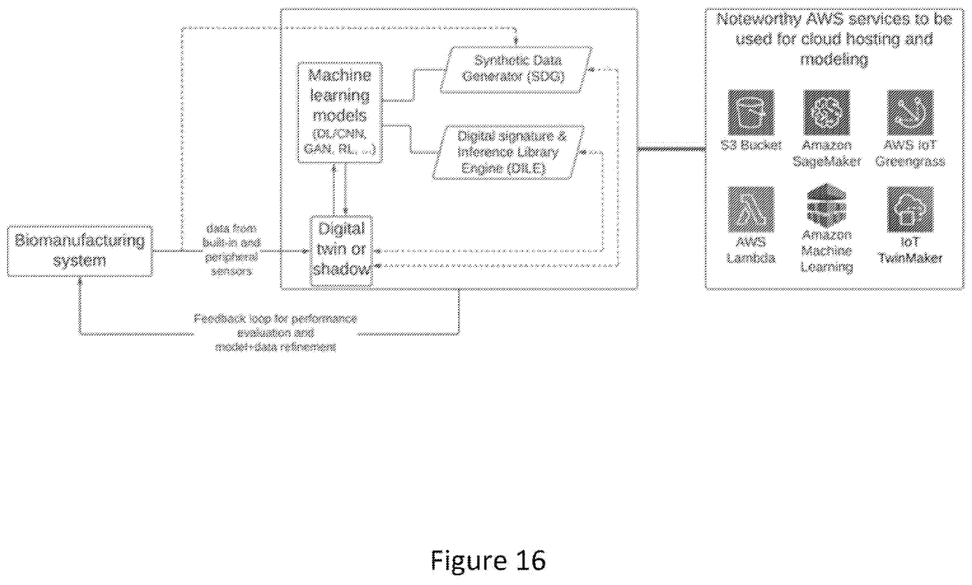

FIG. 16 shows an example of a digital twin deployment infrastructure, per one or more embodiments herein. FIG. 16 depicts the relationship between the physical and digital systems and pertinent dataflows. The digital twin or digital shadow, as well as machine learning models (e.g., deep learning model, convolutional neural network (CNN) model, generative adversarial network (GAN) model, reinforcement learning (RL) model) may be hosted on a cloud infrastructure (e.g., Amazon Web Service (AWS)). As illustrated in FIG. 16, AWS that may be used for cloud hosting and modeling may comprise S3 bucket, Amazon SageMaker, AWS Internet of Things (IoT) Greengrass platform, AWS Lambda, Amazon Machine Learning platform, and IoT TwinMaker. In some embodiments, the model components may be tested on other cloud computing platforms including Google cloud platform (GCP) and Microsoft Azure. The physical system may be a manufacturing system with electrical and mechanical subsystems, built-in sensors and peripheral sensors. A real-time feedback loop may be in place between the digital and physical systems to ensure that the model behavior can be optimized, and the predictions can be used in correlation with the real system. The machine learning process may focus on generating synthetic data, digital signatures, and inferences by consuming the real data and the digital twin model's physics-based processes.

### Biomanufacturing Cybersecurity and Cyber-resiliency Using Digital Shadow and Digital Twin Models

In the realm of biomanufacturing, cybersecurity and cyber resiliency can be critical to the safety and reliability of the process. Testing for cybersecurity implications on live manufacturing networks and processes may come with significant safety and business risks. The digital shadow and digital twin models, as described herein, may offer a promising platform to test a biomanufacturing process for security implications. For instance, accurate replica of a physical manufacturing process may allow testing for implications due to parametric changes to the networks and systems. In addition, the feasibility of such manipulations within the networks and systems, as well as the implications on the manufactured end-product may also be tested. Such studies may shed light on the manufacturing network and system-level augmentations to be performed, thereby ensuring secure and safe operations.

In some embodiments, the digital twin and digital shadow models may be used to ensure the cybersecurity and cyber-resiliency of biomanufacturing operations. For example, a variety of tools and frameworks (e.g., digital plant maturity model (DPMM)) are used to assist biomanufacturing facilities to track their digital transformations, the digital twin and digital shadow models may be directly mapped to most controls in DPMM levels 3 to 5. Table 1 lists values provided by the digital twin and digital shadow models and are mapped to DPMM controls.

The digital shadow platform may establish and characterize a resilient process control strategy with fewer physical experiments and fewer pilot trials. This platform enables real-time prediction of process performance and product quality, facilitating virtual exploration of the process design space. This data-driven, science-bases, and risk-aware approach serves as a foundation for the integrated continuous biomanufacturing process control. Future work includes developing a digital twin platform by generating the connections between the virtual model with the physical manufacturing process to achieve fully automated real-time process control.

TABLE 1
Values provided by the digital twin and digital
shadow models and are mapped to DPMM controls.

| DPMM | Digital Twins and Digital shadows can provide value to these controls | | |
|---|---|---|---|
| Domain | Level-3 | Level-4 | Level-5 |
| Manufacturing | | In-line process | Fully automated |
| execution and | | monitoring and | execution without |
| process | | analytical | human participation |
| automation | | technologies enable | (lights out |
| domain | | real-time | manufacturing). |
| | | continuous closed- | Automatic scale up |
| | | loop process | and down based on |
| | | control. | demand. |
| | | Extended use of | Autonomous |
| | | analytics to predict | learning using all |
| | | events (process | available data to |
| | | deviations, machine | create and approve |
| | | breakage) and | new recipe versions. |
| | | increase operational | |
| | | excellence. | |
| Lab and quality | | Predictive analytics | In-line, real-time |
| domain | | embedded in lab | automated process |
| | | management and | monitoring, and |
| | | quality management | release eliminates |
| | | processes. | the need for a |
| | | | traditional quality |
| | | | control (QC) lab. |
| | | | Automated |
| | | | regulatory |
| | | | inspections (no visit |
| | | | to the site). |
| | | | Multi-variate |
| | | | prescriptive |
| | | | analytics with |
| | | | machine learning |
| | | | adjusts parameters |
| | | | to avoid deviations |
| | | | and optimize |
| | | | outcomes. |
| Manufacturing | Three-dimensional | Predictive analytics | |
| support | (3D) facilities | use real-time sensor | |
| | documentation is | data and machine | |
| | used for new | learning to optimize | |
| | design and | utility and building | |
| | construction. | operations. | |
| | | Virtual reality | |
| | | provides an | |
| | | immersive training | |
| | | experience. | |
| | | 3D facilities | |
| | | documentation (a | |
| | | “digital twin” of the | |
| | | plant) is integrated | |
| | | into maintenance, | |
| | | change control, | |
| | | training, and | |
| | | operational systems. | |
| | | Human shop floor | |
| | | activities are guided | |
| | | by the digital plant | |
| | | model and | |
| | | augmented reality. | |
| | | Predictive | |
| | | maintenance. | |
| Business | Continuous process | Real-time proactive | Continuous real- |
| insights and | monitoring is in | and predictive | time analytics |
| analytics | place, with islands | analytics are used | evaluate internal |
| | of real-time | across people, | and external data for |
| | process analytics. | process and | trends and risks. |
| | Simulation and | technology in the | Predictive models |
| | multi-variate data | end-to-end value | are used for |
| | analysis (MVDA) | chain. | proactive actions, |
| | are used for | Machine learning | and are |
| | process modeling | implemented for | continuously |
| | and improvement | operational | improved through |
| | at a plant level. | excellence. | machine learning. |
| | | Real-time | Model based |
| | | simulation and | process control is |
| | | multi-variate data | part of regulatory |
| | | analysis (MVDA) | filings |
| | | are used for | Cognitive |
| | | automated process | computing enables |
| | | adjustment. | autonomous plant |
| | | | operations. |
| System | | Compliance | Artificial |
| interoperability | | framework allows | intelligence and |
| and governance | | predictive analytics, | machine learning |
| | | machine learning, | identify |
| | | and artificial | opportunities and |
| | | intelligence to be | risks and propose |
| | | used in good | solutions. People |
| | | practice (GxP) | decide which to |
| | | applications. | enact. |
| | | | Global standards |
| | | | extend to include |
| | | | integration of |
| | | | mobile robots |
| | | | (cobots) and plug-n- |
| | | | play integration of |
| | | | new modular |
| | | | manufacturing |
| | | | systems. |
| Information | | | Information |
| technology (IT) | | | technology (IT) and |
| Security and | | | operational |
| Operations | | | technology (OT) |
| | | | infrastructure is |
| | | | self-healing and |
| | | | requires zero |
| | | | downtime for |
| | | | patches and |
| | | | upgrades. |
| | | | IT and OT |
| | | | infrastructure |
| | | | monitors itself |
| | | | continuously for |
| | | | intrusions and |
| | | | threats. |
| | | | Threat response is |
| | | | automatic. |
| | | | Automated attack |
| | | | and penetration |
| | | | testing is built into |
| | | | the fabric of IT and |
| | | | OT operations |

### Machine Learning

In some embodiments, the machine learning algorithms herein employ one or more forms of labels including but not limited to human annotated labels and semi-supervised labels. In some embodiments, the machine learning algorithm utilizes regression modeling, wherein relationships between predictor variables and dependent variables are determined and weighted.

The human annotated labels can be provided by a hand-crafted heuristic. For example, the hand-crafted heuristic can comprise examining output differences between CO₂ and nutrient inputs. The semi-supervised labels can be determined using a clustering technique to find properties similar to those flagged by previous human annotated labels and previous semi-supervised labels. The semi-supervised labels can employ a XGBoost, a neural network, or both.

In some embodiments, the machine learning methods herein employ a distant supervision method. The distant supervision method can create a large training set seeded by a small hand-annotated training set. The distant supervision method can comprise positive-unlabeled learning with the training set as the ‘positive’ class. The distant supervision method can employ a logistic regression model, a recurrent neural network, or both. The recurrent neural network can be advantageous for Natural Language Processing (NLP) machine learning.

Examples of machine learning algorithms can include a support vector machine (SVM), a naïve Bayes classification, a random forest, a neural network, deep learning, or other supervised learning algorithm or unsupervised learning algorithm for classification and regression. The machine learning algorithms can be trained using one or more training datasets.

In some embodiments, a machine learning algorithm is used to select catalogue images and recommend project scope. A non-limiting example of a multi-variate linear regression model algorithm is seen below: probability=A₀+A₁(X₁)+A₂(X₂)+A₃(X₃)+A₄(X₄)+A₅(X₅)+A₆(X₆)+A₇(X₇) . . . , wherein Aᵢ (A₁, A₂, A₃, A₄, A₅, A₆, A₇, . . . ) are “weights” or coefficients found during the regression modeling; and Xᵢ (X₁, X₂, X₃, X₄, X₅, X₆, X₇, . . . ) are data collected from the user. Any number of Aᵢ and Xᵢ variable can be included in the model. For example, in a non-limiting example wherein there are 7 Xᵢ terms, X₁ is the number of input parameter, X₂ is the number of measured data parameters, and X₃ is the number of sites. In some embodiments, the programming language “R” is used to run the model.

### Computing System

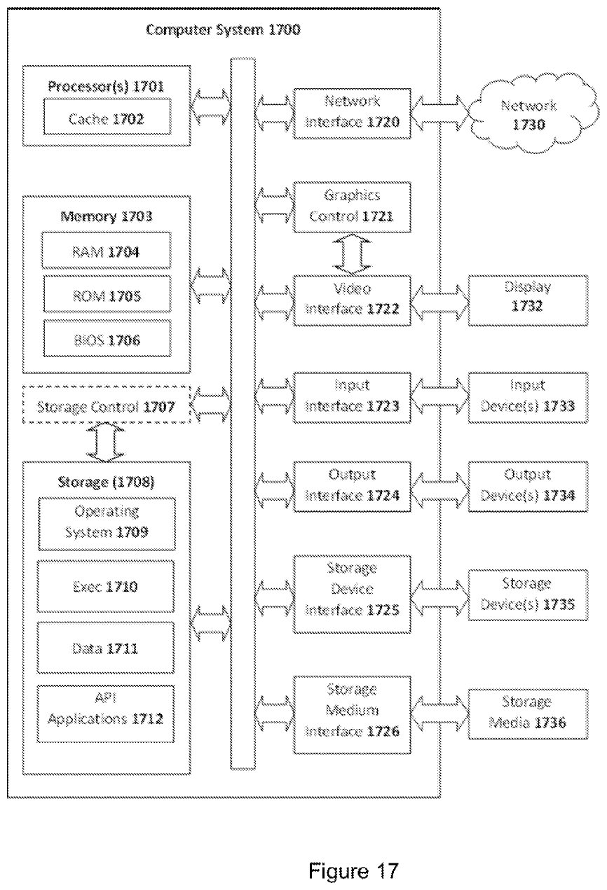

Referring to FIG. 17, a block diagram is shown depicting an exemplary machine that includes a computer system 1700 (e.g., a processing or computing system) within which a set of instructions can execute for causing a device to perform or execute any one or more of the aspects and/or methodologies for static code scheduling of the present disclosure. The components in FIG. 17 are examples only and do not limit the scope of use or functionality of any hardware, software, embedded logic component, or a combination of two or more such components implementing particular embodiments.

Computer system 1700 may include one or more processors 1701, a memory 1703, and a storage 1708 that communicate with each other, and with other components, via a bus 1740. The bus 1740 may also link a display 1732, one or more input devices 1733 (which may, for example, include a keypad, a keyboard, a mouse, a stylus, etc.), one or more output devices 1734, one or more storage devices 1735, and various tangible storage media 1736. All of these elements may interface directly or via one or more interfaces or adaptors to the bus 1740. For instance, the various tangible storage media 1736 can interface with the bus 1740 via storage medium interface 1726. Computer system 1700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1700 includes one or more processor(s) 1701 (e.g., central processing units (CPUs) or general purpose graphics processing units (GPGPUs)) that carry out functions. Processor(s) 1701 optionally contains a cache memory unit 1702 for temporary local storage of instructions, data, or computer addresses. Processor(s) 1701 are configured to assist in execution of computer readable instructions. Computer system 1700 may provide functionality for the components depicted in FIG. 17 as a result of the processor(s) 1701 executing non-transitory, processor-executable instructions embodied in one or more tangible computer-readable storage media, such as memory 1703, storage 1708, storage devices 1735, and/or storage medium 1736. The computer-readable media may store software that implements particular embodiments, and processor(s) 1701 may execute the software. Memory 1703 may read the software from one or more other computer-readable media (such as mass storage device(s) 1735, 1736) or from one or more other sources through a suitable interface, such as network interface 1720. The software may cause processor(s) 1701 to carry out one or more processes or one or more steps of one or more processes described or illustrated herein. Carrying out such processes or steps may include defining data structures stored in memory 1703 and modifying the data structures as directed by the software.

The memory 1703 may include various components (e.g., machine readable media) including, but not limited to, a random access memory component (e.g., RAM 1704) (e.g., static RAM (SRAM), dynamic RAM (DRAM), ferroelectric random access memory (FRAM), phase-change random access memory (PRAM), etc.), a read-only memory component (e.g., ROM 1705), and any combinations thereof. ROM 1705 may act to communicate data and instructions unidirectionally to processor(s) 1701, and RAM 1704 may act to communicate data and instructions bidirectionally with processor(s) 1701. ROM 1705 and RAM 1704 may include any suitable tangible computer-readable media described below. In one example, a basic input/output system 1706 (BIOS), including basic routines that help to transfer information between elements within computer system 1700, such as during start-up, may be stored in the memory 1703.

Fixed storage 1708 is connected bidirectionally to processor(s) 1701, optionally through storage control unit 1707. Fixed storage 1708 provides additional data storage capacity and may also include any suitable tangible computer-readable media described herein. Storage 1708 may be used to store operating system 1709, executable(s) 1710, data 1711, applications 1712 (application programs), and the like. Storage 1708 can also include an optical disk drive, a solid-state memory device (e.g., flash-based systems), or a combination of any of the above. Information in storage 1708 may, in appropriate cases, be incorporated as virtual memory in memory 1703.

In one example, storage device(s) 1735 may be removably interfaced with computer system 1700 (e.g., via an external port connector (not shown)) via a storage device interface 1725. Particularly, storage device(s) 1735 and an associated machine-readable medium may provide non-volatile and/or volatile storage of machine-readable instructions, data structures, program modules, and/or other data for the computer system 1700. In one example, software may reside, completely or partially, within a machine-readable medium on storage device(s) 1735. In another example, software may reside, completely or partially, within processor(s) 1701.

Bus 1740 connects a wide variety of subsystems. Herein, reference to a bus may encompass one or more digital signal lines serving a common function, where appropriate. Bus 1740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1700 may also include an input device 1733. In one example, a user of computer system 1700 may enter commands and/or other information into computer system 1700 via input device(s) 1733. Examples of an input device(s) 1733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1733 may be interfaced to bus 1740 via any of a variety of input interfaces 1723 (e.g., input interface 1723) including, but not limited to, serial, parallel, game port, USB, FIREWIRE, THUNDERBOLT, or any combination of the above.

In particular embodiments, when computer system 1700 is connected to network 1730, computer system 1700 may communicate with other devices, specifically mobile devices and enterprise systems, distributed computing systems, cloud storage systems, cloud computing systems, and the like, connected to network 1730. Communications to and from computer system 1700 may be sent through network interface 1720. For example, network interface 1720 may receive incoming communications (such as requests or responses from other devices) in the form of one or more packets (such as Internet Protocol (IP) packets) from network 1730, and computer system 1700 may store the incoming communications in memory 1703 for processing. Computer system 1700 may similarly store outgoing communications (such as requests or responses to other devices) in the form of one or more packets in memory 1703 and communicated to network 1730 from network interface 1720. Processor(s) 1701 may access these communication packets stored in memory 1703 for processing.

Examples of the network interface 1720 include, but are not limited to, a network interface card, a modem, and any combination thereof. Examples of a network 1730 or network segment 1730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1730, may employ a wired and/or a wireless mode of communication. In general, any network topology may be used.

Information and data can be displayed through a display 1732. Examples of a display 1732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1732 can interface to the processor(s) 1701, memory 1703, and fixed storage 1708, as well as other devices, such as input device(s) 1733, via the bus 1740. The display 1732 is linked to the bus 1740 via a video interface 1722, and transport of data between the display 1732 and the bus 1740 can be controlled via the graphics control 1721. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1732, computer system 1700 may include one or more other peripheral output devices 1734 including, but not limited to, an audio speaker, a printer, a storage device, and any combinations thereof. Such peripheral output devices may be connected to the bus 1740 via an output interface 1724. Examples of an output interface 1724 include, but are not limited to, a serial port, a parallel connection, a USB port, a FIREWIRE port, a THUNDERBOLT port, and any combinations thereof.

In addition or as an alternative, computer system 1700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

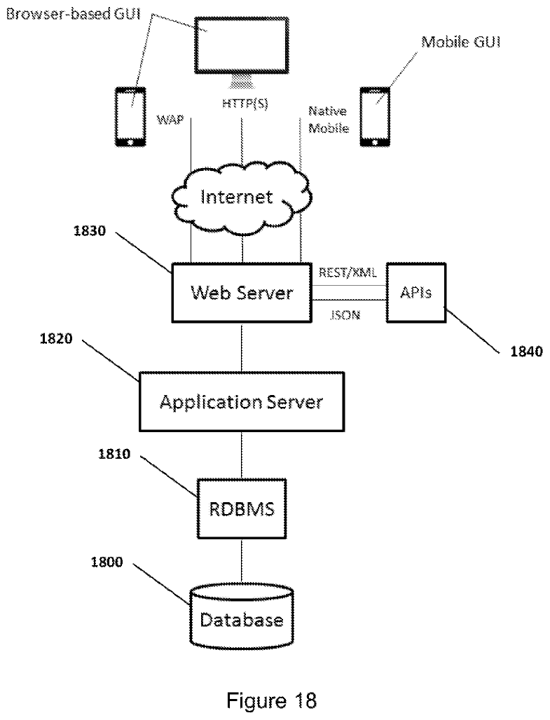

Referring to FIG. 18, in a particular embodiment, an application provision system comprises one or more databases 1800 accessed by a relational database management system (RDBMS) 1810. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 1820 (such as Java servers, .NET servers, PHP servers, and the like) and one or more web servers 1830 (such as Apache, IIS, GWS and the like). The web server(s) optionally expose one or more web services via app application programming interfaces (APIs) 1840. Via a network, such as the Internet, the system provides browser-based and/or mobile native user interfaces.

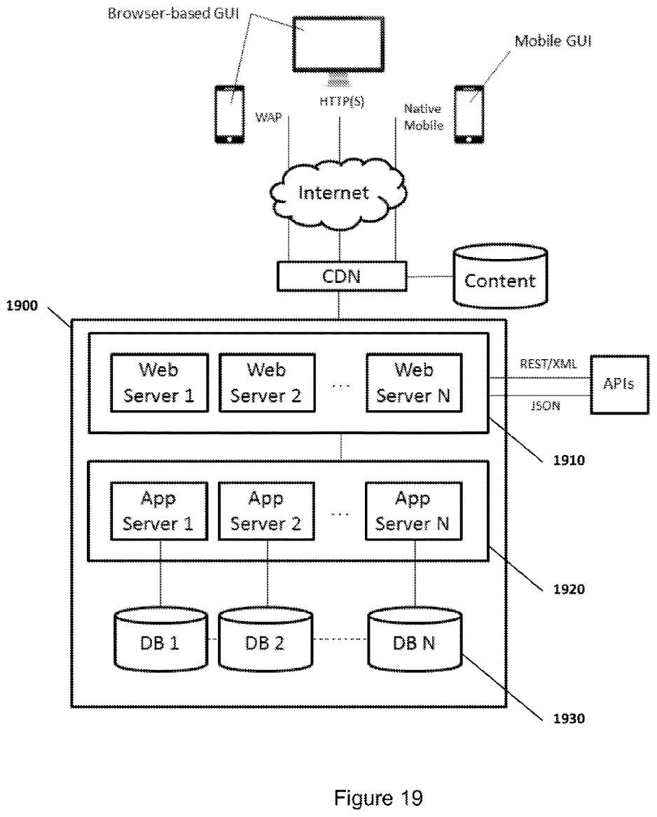

Referring to FIG. 19, in a particular embodiment, an application provision system alternatively has a distributed, cloud-based architecture 1900 and comprises elastically load balanced, auto-scaling web server resources 1910 and application server resources 1920 as well synchronously replicated databases 1930.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of biological manufacturing parameters. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the term “real-time” generally refers to a response time of less than 10 minutes, 1 minutes, 1 second, tenth of a second, hundredth of a second, a millisecond, or less, such as by a computer processor. Real-time can also refer to a simultaneous or substantially simultaneous occurrence of a first event with respect to occurrence of a second event. Substantially as used in the above context may refer to a deviation of between =1% to =10% of an expected response time, execution time or execution speed.

As used herein, the term “metadata” refers to data that describes other data that may serve as an informative label.

As used herein, the term “telemetry” refers to the automatic recording and transmission of data from a remote source to a receiving station for analysis.

As used herein, the term “platform as a service (PaaS)” refers to a category of cloud computing services that allow customers to provision, instantiate, run, and manage a modular bundle comprising a computing platform and one or more applications, without the complexity of building and maintaining the infrastructure typically associated with developing and launching the applications.

As used herein, the term “federated learning framework” refers to a machine learning technique that trains an algorithm across multiple decentralized edge devices or servers holding local data samples, without exchanging between the edge devices or servers.

As used herein, the term “Manufacturing Execution System (MES)” refers to an industrial system that focuses on production parameters to speed up and improve decision-making in the plant.

As used herein, the term “Supervisory Control And Data Acquisition (SCADA) refer to a system of supervision, control, and data collection that facilitates remote management by monitoring equipment, interaction between field devices and control and optimization through a set of software and hardware.

As used herein, the term “Extreme Learning Machines” refers to feedforward neural networks for classification, regression, clustering, sparse approximation, compression and feature learning with a single layer or multiple layers of hidden nodes, where the parameters of hidden nodes do not need to be tuned.

As used herein, the term “stochasticity” refers to the property of being well described by a random probability distribution.

As used herein, the term “entropy” refers to a lack of order or predictability.

As used herein, the term “non-orthogonal deviations” refers to data having variates which can be treated as statistically dependent.

As used herein, the term “zero-day cyber attack” refers to a discovered security vulnerabilities that a hacker has already use to attack a system.

As used herein, the term “internet of things” refers to a plurality of physical objects with sensors, processing ability, software, and other technologies that connect and exchange data with other devices and systems over the Internet or other communications networks.

As used herein, the term “edge internet of things” refers to an internet of things system with low latency.

What is claimed is:

1. A method for cyber and/or physical anomaly detection in a biopharmaceutical research and/or manufacturing (biopharma) environment, the method comprising:
obtaining and aggregating data from a plurality of sources within the biopharma environment, wherein the plurality of sources comprise a plurality of biopharma production systems and machine networks, and wherein the data comprises telemetric data and metadata associated with the plurality of biopharma production systems and machine networks;
providing the aggregated data to one or more machine learning algorithms for training and analysis; and
using the one or more trained machine learning algorithms to detect, identify or predict one or more cyber and/or physical anomalies that have occurred, are occurring, or are likely to occur within the biopharma environment.

2. The method of claim 1, wherein the data is aggregated using a module that is configured to (1) automatically synchronize the telemetric data across the plurality of biopharma production systems and machine networks, and (2) extract the metadata from the plurality of biopharma production systems and machine networks.

3. The method of claim 1, wherein the plurality of biopharma production systems comprise one or more bioreactors.

4. The method of claim 1, wherein the one or more machine learning algorithms are configured to analyze patterns in sensor outputs or signal characteristics from the biopharma production systems, wherein the sensor outputs or signal characteristics comprise one or more of the following: frequency, voltage, temperature, pressure, acoustics or images.

5. The method of claim 4, wherein the images comprise at least one image or video of a product(s) or process(es) from one or more phases of a bioproduction cycle carried out using the biopharma production systems.

6. The method of claim 5, wherein the product(s) comprise partially-manufactured products and/or fully-manufactured products.

7. The method of claim 5, wherein the product(s) or process(es) from the one or more phases of the bioproduction cycle are associated with one or more of the following: inoculation, capture, seed cultivation, virus inactivation, cell culture, polishing, product recovery, or formulation.

8. The method of claim 4, wherein the one or more machine learning algorithms are further configured to correlate the sensor outputs or signal characteristics to a set of input commands and/or instructions to the biopharma production systems, to determine whether the biopharma production systems are experiencing or likely to experience anomalies or behavioral deviations.

9. The method of claim 8, wherein the set of input commands and/or instructions comprise (1) operator/user commands provided to production workstations or (2) Supervisory control and data acquisition (SCADA) control commands that are sent to individual controllers of the biopharma production systems.

10. The method of claim 9, wherein the one or more machine learning algorithms are further configured to detect whether the anomalies or behavioral deviations are due to (1) machine faults or issues occurring in the biopharma production systems and machine networks, (2) operator/user errors, or (3) an external cyberattack on the biopharma production systems and machine networks.

11. The method of claim 1, further comprising: generating one or more remedial recommendations or actions to localize, resolve or reduce an impact of the one or more cyber and/or physical anomalies on the biopharma environment.

12. The method of claim 11, wherein the one or more remedial recommendations or actions include predictive maintenance on one or more of the biopharma production systems.

13. The method of claim 1, further comprising: constructing a digital twin model of the biopharma environment based at least in part on the analyzed data from the one or more machine learning algorithms.

14. The method of claim 13, wherein the digital twin model is implemented via a Platform as a Service (PaaS).

15. The method of claim 13, wherein the digital twin model is configured to enable virtual simulation, analysis and/or optimization of the biopharma environment.

16. The method of claim 13, wherein the digital twin model is configured to enable remote operation or control of the biopharma environment.

17. The method of claim 1, wherein the one or more machine learning algorithms are initially trained in a cloud-based environment.

18. The method of claim 17, wherein the one or more trained machine learning algorithms are subsequently deployed on edge, and configured to run locally within the biopharma environment to generate inferences and perform quality assessment.

19. The method of claim 1, wherein the one or more machine learning algorithms comprise a neural network and/or a clustering algorithm.

20. The method of claim 13, further comprising: constructing a global model comprising of the (1) digital twin model of the biopharma environment and (2) at least one other digital twin model of another biopharma environment.

21. The method of claim 21, wherein the global model is trained in a distributed manner based on a federated learning framework.

22. A method for modeling a biopharma environment, the method comprising:
obtaining and aggregating data from a plurality of sources within the biopharma environment, said bioreactor environment comprising at least one bioreactor system;
providing bioreactor data from the aggregated data relating to one or more physical components of a bioreactor system to machine learning algorithms for training and analysis to generate a bioreactor system level model;
providing cell data from the aggregated data relating to cell dynamics within the bioreactor system to machine learning algorithms for training and analysis to generate a bioreactor cell level model;
providing fluidic data from the aggregated data relating to hydrodynamics or local fluidic phenomenon within the bioreactor system to machine learning algorithms for training and analysis to generate a bioreactor computational fluid dynamics model; and
obtaining data from the bioreactor system level model, the bioreactor cell level model, and the bioreactor computational fluid dynamics model at a bioreactor hybrid model to generate one or more predictive values pertaining to the biopharma environment.

23. A method for calibration of a biopharma model, the method comprising:
accessing experimental data collected with aid of one or more physical instruments associated with a bioreactor system;
analyzing the experimental data to generate (1) estimation data indicative of uncertainty, and (2) cross-validation data;
performing a validation step of the biopharma model by comparing one or more predicted values from the biopharma model of the bioreactor system with the cross-validation data, wherein said comparison incorporates the estimation data; and
reconfiguring the bioreactor system or the biopharma model with aid of a neural network or mechanistic correction, when an indication the biopharma calibration is not complete is provided, based on the comparison during the validation step.
